SEQUENCE LISTING (4 sequences)

SEQ ID NO: 1 - DNA, 15 bp, Artificial Sequence
  Description of Artificial Sequence Synthetic oligonucleotide
tgcaccctgattagg

SEQ ID NO: 2 - DNA, 246 bp, Mouse mammary tumor virus
aatggctataaagtgttatacagatccctcccctttcgtgaaagactcgccagagctagacctccttggtgtgtgttaactcaggaagaaaaagacgacatgaaacaacaggtacatgattatatttatctaggaacaggaatgaacgtttgggggaagatttttcattataccaaggagggggcagtggctagactattagaacatatttctgcagatacttttggcatgagttataatggataa

SEQ ID NO: 3 - DNA, 50 bp, Vitis sp.
tctcgctgaagcccattatggattaccctaatgagaacccaattttagtt

SEQ ID NO: 4 - DNA, 50 bp, Vitis sp.
tctcattgaagcccattatggaagggcctaatgagaatccaatttgagtt

(19) United States
(12) Patent Application Publication
(10) Pub. No.: US 2011/0280466 A1
(43) Pub. Date: Nov. 17, 2011

(54) SYSTEMS AND METHODS FOR GENETIC IMAGING

(76) Inventors: Kiho Cho, Davis, CA (US); David G. Greenhalgh, Davis, CA (US)

(21) Appl. No.: 12/781,679

(22) Filed: May 17, 2010

(51) Int. Cl. G06K 9/00; G06F 3/12; G06F 19/00

(52) U.S. Cl. 382/133; 702/19; 358/1.15

(57) ABSTRACT

Sequence data, e.g., genetic sequence data such as nucleic acid or amino acid sequences, can be represented in Genetic Images, as defined herein, that provide a compact, portable image that can be analyzed electronically (e.g., by computer) or optically, e.g., visually or by optical scanning devices. New methods and systems are described by which sequence data is first converted into a numeric data set, which is, in turn, encoded to form a Genetic Image. The Genetic Image can be traced backwards to determine the original sequence data.

### GOVERNMENT SUPPORT

The inventions described herein were made, at least in part, with government support under a grant from the National Institute of General Medical Sciences (NIGMS R01GM071360). The Government has certain rights to the invention.

### TECHNICAL FIELD

This invention relates to genetic imaging, and more particularly to systems and methods for making genetic images, starting with raw biological sequence data.

### BACKGROUND

Advances in sequencing technology have contributed to a rapid accumulation of a vast amount of genetic information from genomes and their transcribed molecules (RNAs) of a variety of species, which are subjected to biological investigations. One of the key biomedical applications of the genomic sequence data is to identify genetic polymorphisms associated with a vast range of disease processes by alignment analysis against a reference. The alignment analysis of genetic sequence information is rather cumbersome especially when the size of the sequences to be compared is large, and this requires a certain level of training in molecular biology and genomics.

Recent focus on the personalized genome project suggests that the genetic sequence data from individuals, and presumably from animals and plants as well, can be used as a tool for specific identification for medical as well as administrative purposes. However, most genetic sequence data are simply too bulky to be used as a tool for rapid daily identification purposes.

### SUMMARY

The invention is based, at least in part, on the discovery that genetic sequence data, e.g., nucleic acid or amino acid sequences, can be represented in new, so-called Genetic Images, that provide a compact, portable image that can be analyzed electronically (e.g., by computer) or optically, e.g., visually or by optical scanning devices. In the new methods, genetic sequence data for a given sequence is first converted into a numeric data set, which is, in turn, encoded to form a Genetic Image. The Genetic Image can be traced backwards to determine the original genetic sequence data.

In one aspect, the invention features computer-implemented methods of forming a numeric data set that represents a nucleotide sequence. These methods include receiving electronic information representing a nucleotide sequence comprising a contiguous series of nucleotides; obtaining an electronic set of Genetic Analyzers, wherein each Genetic Analyzer comprises “n” nucleotides; wherein the set comprises all possible combinations of “X” different nucleotides present in the nucleotide sequences at each of “n” positions of a Genetic Analyzer in the set; wherein the set has a known order of Genetic Analyzers; wherein Xⁿ is the number of Genetic Analyzers in the set; and wherein each Genetic Analyzer has a unique sequence that provides a cut site within the nucleotide sequence at a specified site within or at an end of each segment of “n” nucleotides that is identical to a given Genetic Analyzer; converting the nucleotide sequence with the ordered set of Genetic Analyzers into numeric data that comprises a series of groups of numbers, wherein a group of numbers is generated for each unique Genetic Analyzer of the set of Genetic Analyzers, with each number in the group comprising a total number of nucleotides between successive cut sites in the nucleotide sequence provided by the given unique Genetic Analyzer, and wherein the groups of numbers in the numeric data set are organized in the known order of the set of Genetic Analyzers; and generating a numeric data set that comprises, in order, the first n−1 nucleotides of a 5′ end of the nucleotide sequence, the numeric data, and a 3′ nucleotide of the nucleotide sequence.

These methods can further include encoding the numeric data set into an electronic representation of a genetic image; and storing the electronic representation of the Genetic Image in a machine-readable storage device. These methods can also further include displaying the electronic representation on a display device to provide a visible genetic image and/or providing the electronic representation to a printer and printing a visible genetic image on a substrate.

In another aspect, the invention features tangible machine-readable storage devices that include a digital representation of an ordered set of Genetic Analyzers, wherein the set of Genetic Analyzers includes a digital representation of a series of nucleotide sequences; wherein each Genetic Analyzer includes “n” nucleotides; wherein the set includes all possible combinations of “X” different nucleotides present in the nucleotide sequences at each of “n” positions of a Genetic Analyzer in the set; wherein the set has a known order of Genetic Analyzers; wherein Xⁿ is the number of Genetic Analyzers in the set; and wherein each Genetic Analyzer has a unique sequence that provides a cut site within a nucleotide sequence at a specified site within or at an end of each segment of “n” nucleotides within the nucleotide sequence that is identical to a given Genetic Analyzer.

In these storage devices, the order of the Genetic Analyzers within the set can be, for example, alphabetical. In certain embodiments of these storage devices, n=4 and X=4. In various embodiments, the storage device can be a memory within a computer or a portable and tangible machine-readable medium.

In another aspect, the invention also includes articles of manufacture that are or include a tangible object; and a Genetic Image displayed on the tangible object, wherein the Genetic Image comprises non-alphanumeric markings in machine-readable form, wherein the Genetic Image when read by a machine causes a processor to decode the Genetic Image into a numeric data set and convert the numeric data set into a specific genetic sequence, such as a nucleotide or amino acid sequence. The tangible objects in these articles of manufacture can be, for example, a container, piece of paper or plastic, or a label, or any other article upon which a Genetic Image can be represented, such as an electronic display device. In these Genetic Images, the image can be an array of colored pixels.

The invention also includes tangible machine-readable storage devices that include a numeric data set that when read by a machine can causes a processor to (a) encode the numeric data set into an electronic representation of a Genetic Image, wherein the Genetic Image comprises non-alphanumeric markings in machine-readable form, wherein the Genetic Image when read by a machine causes a processor to decode the genetic image to provide a specific genetic sequence; or (b) convert the numeric data set into a specific genetic sequence.

In these tangible storage devices, the storage device can be or include an electronic memory within a computer, a universal serial bus (USB) compatible memory, or a magnetic or optical disk.

The invention also includes methods of generating sets of Genetic Analyzers. These methods include selecting a length “n” of a sequence of characters in each Genetic Analyzers; selecting “X” as the number of different characters in each Genetic Analyzer; calculating all possible combinations of “X” different characters present in a sequence at each of “n” positions of a Genetic Analyzer to create a basic set of Xⁿ Genetic Analyzers; arranging the basic set of Genetic Analyzers in a specific order to create an ordered set of Genetic Analyzers; and storing the ordered set of Genetic Analyzers in a machine-readable storage medium.

In these methods, the ordered set of Genetic Analyzers can include a digital representation of a series of nucleotide sequences; wherein each Genetic Analyzer includes “n” nucleotides; wherein the set comprises all possible combinations of “X” different nucleotides present in the nucleotide sequences at each of “n” positions of a Genetic Analyzer in the set; wherein the set has a known order of Genetic Analyzers; wherein Xⁿ is the number of Genetic Analyzers in the set; and wherein each Genetic Analyzer has a unique sequence that provides a cut site within a nucleotide sequence at a specified site within or at an end of each segment of “n” nucleotides within the nucleotide sequence that is identical to a given Genetic Analyzer. For example, “n” can be 4, and the characters can be nucleic acids or amino acids.

In yet another aspect, the invention features methods of reading a Genetic Image that represents a nucleotide sequence. These methods include obtaining an article of manufacture that has one or more Genetic Images as described herein; scanning the article of manufacture to convert markings of the Genetic Image into electronic data; decoding the electronic data to obtain a numeric data set that represents at least one nucleotide sequence; and converting the numeric data set into a nucleotide sequence. For example, converting the numeric data set into a nucleotide sequence can include the use of a known ordered set of Genetic Analyzers, as described herein.

The invention also includes methods of comparing two or more nucleotide sequences by obtaining at least two articles of manufacture with Genetic Images as described herein representing first and second nucleotide sequences; scanning the articles of manufacture to convert markings of the respective Genetic Images into electronic data representing the first and second nucleotide sequences; comparing the electronic data representing the first and second nucleotide sequences to locate any differences; decoding the electronic data of any differences to obtain numeric data sets that represent the differences between the first and second nucleotide sequences; and converting the numeric data sets using an ordered set of Genetic Analyzers to provide a nucleotide sequence representing the differences between the first and second nucleotide sequences.

In another aspect, the invention also includes systems for generating Genetic Images that includes a processor; a machine-readable storage device; and an ordered set of Genetic Analyzers as described herein in the storage device; wherein the processor is programmed with a program that causes the processor to: receive electronic information representing a nucleotide sequence including a contiguous series of nucleotides; obtain the ordered set of Genetic Analyzers from the storage device; convert the nucleotide sequence with the ordered set of Genetic Analyzers into numeric data that comprises a series of groups of numbers, wherein a group of numbers is generated for each unique genetic analyzer of the set of Genetic Analyzers, with each number in the group comprising a total number of nucleotides between successive cut sites in the nucleotide sequence provided by the given unique Genetic Analyzer, and wherein the groups of numbers in the numeric data set are organized in the known order of the set of Genetic Analyzers; and generate a numeric data set that comprises, in order, the first n−1 nucleotides of a 5′ end of the nucleotide sequence, the numeric data, and a 3′ nucleotide of the nucleotide sequence.

In these systems, the processor can be further programmed to encode the numeric data set into an electronic representation of a Genetic Image; and store the electronic representation of the Genetic Image in a machine-readable storage device. These systems can further include a display device and the processor can be further programmed to display the electronic representation on the display device to provide a visible Genetic Image. These systems can further include a printer and the processor can be further programmed to provide the electronic representation to the printer and to cause the printer to print a visible Genetic Image on a substrate.

The invention also features systems for reading Genetic Images. These systems include a processor; a machine-readable storage device; a scanner that scans an image and converts the image into electronic data; and an ordered set of Genetic Analyzers as described herein in the storage device; wherein the processor is programmed with a program that causes the processor to: obtain the electronic data from the scanner; obtain the ordered set of Genetic Analyzers from the storage device; decode the electronic data to obtain a numeric data set that represents at least one nucleotide sequence, wherein the electronic data comprises a series of groups of numbers, and wherein a group of numbers is generated for each unique Genetic Analyzer of the set of Genetic Analyzers, with each number in the group comprising a total number of nucleotides between successive cut sites in the nucleotide sequence provided by the given unique Genetic Analyzer, and wherein the groups of numbers in the numeric data set are organized in the known order of the set of Genetic Analyzers; and convert the numeric data set into a nucleotide sequence with the ordered set of Genetic Analyzers.

### DEFINITIONS

As used herein, a “Genetic Image” is a representation, e.g., a marking on a tangible, physical object, or an image on a screen or monitor, or an electronic representation stored on a machine-readable medium, of genetic sequence data that has been converted into a machine-readable numeric data set and then encoded to form the Genetic Image. The genetic sequence data represents at least one biopolymer sequence, such as a nucleic acid sequence, e.g., DNA or RNA, or an amino acid sequence. FIG. 1A includes an exemplary, stylized Genetic Image composed of bisected squares, wherein various characteristics of the squares such as color, size, intensity, location, etc. together symbolize an encoded, machine-readable representation of a numeric data set converted from sequence data. As used herein, a Genetic Image includes the sequence data encoded in machine-readable form, for example, as an intangible data pattern, e.g., on a computer or television monitor or on a telephone or personal digital assistant (PDA) screen, or stored and analyzed electronically in a computer or other device, or incorporated into a tangible, physical object, such as a paper or plastic label or a plastic, metal, or ceramic sheet, disk, or card.

Genetic sequence data is first converted into a numeric data set, and then that numeric data set is encoded to form the Genetic Image that is machine readable. Such a Genetic Image is machine readable, in that an automated optical or non-optical (e.g., electronic) process can be employed to input or “read” the encoded sequence data for analysis and/or further processing. In some embodiments, a human can visually read the Genetic Image. In various embodiments, encoded sequence data can include alphanumeric data, or can be incorporated into a form such as a radiofrequency identification (RFID) element, hologram, a solid state memory element, a magnetic element, a magneto-optical element, an optical disc element, an image format such as a Joint Photographics Experts Group (JPEG) image or Portable Network Graphics (PNG) image, or the like. In some embodiments, the sequence data is encoded as a PNG. FIG. 1A shows a Genetic Image in the form of a color-based PNG that represents certain genetic information of endogenous retroviral sequences of grapes. Thus, the actual genetic information (e.g., in the form of restriction fragment length polymorphism analysis of grape endogenous retroviral sequences) is encoded in the PNG Genetic Image and is a visual and/or machine-readable representation of the data.

As used herein, a biopolymer is a molecule that comprises a plurality of biologically derived monomer units bonded in a particular sequence. Typical examples include nucleic acid sequences, such as DNA, RNA, and the like, and amino acid sequences, such as polypeptides and proteins. Thus, the monomer units can include ribonucleotides, ribonucleosides, deoxyribonucleotides, deoxyribonucleosides, amino acids, and the like. The monomer units can also include unnatural or synthetic amino acids, nucleotides, or nucleosides, or unnatural or synthetic compounds employed to mimic, substitute, or replace natural amino acids, nucleotides, or nucleosides. Accordingly, the biopolymer can include natural and unnatural peptides, proteins, enzymes, antibodies, polynucleotides or polynucleotides such as single or multiple stranded DNA or RNA, messenger RNA (e.g., messenger RNA derived from primary blood mononuclear cells), peptide nucleic acids, and the like. Note, therefore, that the term “genetic” in “Genetic Image” is illustrative and is not intended to limit the sequence data to DNA or RNA sequences from a natural genome, or peptide, proteins, etc. that correspond to a natural genome.

As used herein, genetic sequence data is information that describes at least a portion of the sequence of a biopolymer. Typical examples include genomic sequence data, such as the sequence of a genome, a chromosome, a gene, a transposon, retrotransposon, endogenous retroviral element, retrovirus genome, retrovirus protein, or portion thereof, or the like. In various embodiments, the sequence data can represent a continuous portion of the biopolymer; a full sequence of the biopolymer; a polymorphic sequence; a restriction fragment length polymorphism (RFLP) profile, or a single nucleotide polymorphism (SNP) profile, or the like.

As used herein, “non-sequence” data is any data of interest other than the sequence data. Typical examples of non-sequence data can describe one or more aspects of a subject, a phylogenetic classification, an organism, a cell, a sample, an experiment, a data origin, a name, a chromosome, a gene, a transposon, a retrovirus, a trademark or other commercial mark, an identifier such as a license or permit number, a government regulatory stamp or approval code, or the like. The non-sequence data can be human readable and/or can be encoded in a machine-readable format. In various embodiments, the non-sequence data can be encoded in a format compatible with Automatic Identification and Data Capture (AIDC). In some embodiments, the sequence data and the non-sequence data can each be independently encoded in alphanumeric data, or into a form such as a barcode, a hologram, a radiofrequency identification (RFID) element, a solid state memory element, a magnetic element, a magneto-optical element, an optical disc element, an image format such as PNG or JPEG, or the like. In particular embodiments, at least a portion of the non-sequence data can be in a human-readable format, and at least a portion of the sequence data can be encoded in a non-human-readable, machine-readable format, typically an encrypted machine-readable format. Such an embodiment can, for example, permit users to read identifying, non-confidential non-sequence data from a Genetic Image label, while sensitive sequence data, being encoded in the form of the Genetic Image (or optionally encrypted as well), can be held confidential, with access limited to users in possession of a corresponding cryptographic key. In some embodiments, the sequence data and the non-sequence data are each independently encoded in the Genetic Image, such as a PNG image. In various embodiments, at least one of the sequence data and the non-sequence data is encrypted. In certain embodiments, the sequence data and the non-sequence data are encrypted with different encryption keys.

As used herein, a polymorphic sequence is a sequence which is nominally conserved in a population, but which contains two or more distinct particular sequences in that population. Thus, in various embodiments, polymorphic sequence data corresponds to an individual species, subject, cell type, disease state, gene, chromosome, retrovirus, endogenous retroviral element, for example, as compared to other such species, subject, cell type, disease state, gene, chromosome, retrovirus, or endogenous retroviral element.

As used herein, a restriction fragment length polymorphism (RFLP) is a variation in the sequence of a genome that can be detected by digesting the sequence into fragments with restriction enzymes and analyzing the size of the resulting fragments, e.g., by gel electrophoresis. As used herein, a restriction fragment length polymorphism (RFLP) profile includes data that describes a collection of subsequence fragments generated by operation of a restriction enzyme on one or more copies of a parent sequence, such as a DNA or RNA sequence. An RFLP profile typically includes data such as the number of unique fragments, the size of each unique fragment (e.g., as determined by electrophoresis), and/or the number or intensity of each unique fragment, or the like. Typically, an RFLP profile can correspond to sequence data that relates to an individual species, subject, cell type, disease state, gene, chromosome, retrovirus, or endogenous retroviral element, thereby identifying the source of the sequence data.

As used herein, a single nucleotide polymorphism (SNP) is a single nucleotide variation in a genomic nucleic acid sequence, e.g., that differs between different individuals of the same species. Known SNPs or SNP patterns have been shown to correspond to a particular species, individual, cell type, disease state, gene, chromosome, retrovirus, or endogenous retroviral element and can be detected using the methods described herein.

As used herein, a restriction enzyme or restriction endonuclease is a biological protein (enzyme) that recognizes a specific nucleic acid sequence and cuts double-stranded or single-stranded DNA or RNA at a particular location within that specific nucleotide sequence (known as a restriction site).

As used herein, a Genetic Analyzer is a software algorithm that recognizes, in silico, a predefined sequence within a longer sequence, and “cuts” (separates the longer sequence in silico) at a predefined location within or after that predefined sequence. A specific Genetic Analyzer can be referred to by the length of the sequence it recognizes, such as a “four-nucleotide Genetic Analyzer,” which indicates a Genetic Analyzer that recognizes a sequence that is four nucleotides long. A Genetic Analyzer can cut the recognized sequence at the end of that sequence, e.g., just after the fourth of four nucleotides when using a four-nucleotide Genetic Analyzer, or it can cut at some other predefined location within the recognized sequence. Thus, the Genetic Analyzer is not a physical restriction enzyme (it is not a biological protein), but acts like one in silico. As described herein, defined sets of multiple Genetic Analyzers are used to cut long genetic sequence in silico to generate a set of unique fragments that are then recorded, along with additional information, to generate a numeric data set.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1A is a representation of a Genetic Image in the form of a Portable Network Graphics (PNG) (1620×640 pixels) image that represents a set of retroviral elements identified from a sample of red grape genomic DNA using a series of different primers. Each data point represents the total number of fragments generated when a specific sequence is cut with a particular Genetic Analyzer. As described in further detail herein, these elements were cut with a set of 3-nucleotide Genetic Analyzers. The total numbers of generated fragment sizes per Genetic Analyzer are arranged by Genetic Analyzer order and by primer set to create a numeric data set, which was processed by the cutEvolution software to generate the Genetic Image.

FIG. 1B is a schematic summary of the protocol for conversion of genetic sequence information into a numeric data set using Genetic Analyzers and then encoding the numeric data set into a Genetic Image. This Genetic Image can also be traced backwards to determine the original nucleotide sequence.

FIGS. 1C-A to 1C-G are a series of representations illustrating a hypothetical example, and the various steps and elements used to convert a nucleotide string of fifteen nucleotides (the genetic sequence information) into a Genetic Image using a set of sixteen two-nucleotide Genetic Analyzers that represents all possible combinations of two nucleotide-long nucleotides.

FIGS. 2A-C is a set of schematic representations of the conversion of nucleotide sequence information for a segment of a mouse mammary tumor virus (MMTV) superantigen endogenous retroviral sequence into a numeric data set using a set of 3-nucleotide Genetic Analyzers. FIG. 2A shows an entire set of 3-nucleotide Genetic Analyzers. FIG. 2B shows the set of 3-nucleotide Genetic Analyzers of FIG. 2A, but in “cut order.” FIG. 2C is a visualization of the resulting numeric data (size of cut fragments) listed sequentially (left to right by order of the Genetic Analyzers across the top) by cut location on a 246 base pair fragment (listed top to bottom by the sequence location on the left axis) for each Genetic Analyzer so that the relative positions of each nucleotide can be readily identified. The complete nucleotide sequence reconstructed from the numeric data set was confirmed to be identical to the original sequence.

FIG. 2D is an enlarged view of the information in the “box” indicated in FIG. 2C.

FIG. 2E is a schematic representation of the basic modules of a software-based sequence cutter tool program that applies a given Genetic Analyzer to a given genetic sequence using a sequence cutter tool program, referred to herein as the “cutEvolution.” The cutEvolution tool is a program that reads nucleotide sequence files and generates a list of fragment sizes for a given set of Genetic Analyzers of a specific size (e.g., a three-nucleotide Genetic Analyzer). The location and name of the sequence files, the Genetic Analyzers (GA) to be used, and the output location for the data are all defined in the cutEvolution project file.

FIGS. 3A-D area a series of schematic representations of the conversion of a human HIV-1A1 nucleotide sequence into a numeric data set using a set of 4-nucleotide Genetic Analyzers. FIG. 3A shows four different subsets of Genetic Analyzers for 4-nucleotide Genetic Analyzers. Each subset of 4-nucleotide Genetic Analyzers, consisting of 64 analyzers each, is able to account for all positions of a specific nucleotide type (A, C, G, or T). Thus, all together these four subsets will account for all nucleotide positions in a given nucleotide sequence. FIG. 3B represents the cut order of the complete set of 4-nucleotide Genetic Analyzers.

FIG. 3C is a schematic representation that shows the conversion of the HIV-1A1 nucleotide sequence into a numeric data set using the entire set (256 total) of ordered 4-nucleotide Genetic Analyzers shown in FIGS. 3A and 3B. The nucleotide sequence of HIV-1A1 is found under Accession No. AB098331, and was retrieved from an HIV sequence database (see website hiv.lanl.gov on the World Wide Web) and converted into a numeric data set by cutting the sequences with an entire set of 4-nucleotide Genetic Analyzers. The cut fragment sizes were first sequentially arranged by cut order for each Genetic Analyzer, and then these fragment groups were arranged in order of the Genetic Analyzers employed.

FIG. 3D is an enlarged view of the information in the “box” indicated in FIG. 3C.

FIG. 4A is a flowchart showing a method of encoding numeric sequence data starting with the “cutting” process carried out by the cutEvolution software program, and ending with the generation of a Genetic Image. In this exemplary chart, the final Genetic Image is in the form of a PNG image file that is the same as the Genetic Image shown in FIG. 1A.

FIG. 4B is a representation of one method of converting a numeric data set into a Genetic Image using a RGB color scheme for a PNG-based Genetic Image. In this example, two colors are used to represent dataset information (i.e., color 1 indicates the primer subset number, the primer ID number, and the clone number; color 2 represents the size of the Genetic Analyzer and the number of fragments/cuts). These examples represent a flexible scheme that may be modified to include, e.g., different fragment sizes.

FIG. 4C is an exemplary transformation of sequence identification information (Primer and Clone numbers) into a first RGB color, and a pair of Genetic Analyzer and total fragment numbers into a second RGB color by converting decimal values into base 256 numbers.

FIG. 4D is a color representation of four data points in a PNG-based Genetic Image. Each data point is represented as a bisected “box” containing 10×10 pixels and two colors (with each color representing the data as shown in FIG. 4C). This depicts the orientation of the data points of total number of fragments that were generated for each sequence cut by each Genetic Analyzer.

FIG. 4E is a color PNG-based Genetic Image (1440×640 pixels) of a Genetic Analyzer dataset of white grape retroviral element sequences. Each data point represents the total number of fragments generated when a specific sequence is cut with a particular Genetic Analyzer. This image was generated from a 3-nucleotide Genetic Analyzer analysis of retroelements amplified from grape genomic DNA isolated from white grapes, and shows how the retroviral elements and the resulting Genetic Images differ depending on the type of grapes (e.g., as compared to FIG. 1a, which resulted from a red grape sample).

FIG. 5 is a schematic flow diagram showing how one can trace a polymorphism identified in Genetic Images back to its original nucleotide sequence. The flow diagram explains how the polymorphisms, identified by scanning and overlaying of two different Genetic Images, are traced to the polymorphic nucleotide sequence.

FIG. 6 is a representation of a single nucleotide polymorphism, and resulting alterations in multiple recognition sites for Genetic Analyzers and relevant cut fragment profile. For the 4-nucleotide Genetic Analyzers, a single nucleotide polymorphism results in the removal or addition of recognition sites for four Genetic Analyzers. As a result, there are changes in 24 numeric data points.

FIGS. 7A and 7B each show a series of images similar to FIGS. 2C, 3C, and 1A. These series of images represent the conversion of two short retroviral element sequences (one from green grapes (FIG. 7A) and one from red grapes (FIG. 7B) into Genetic Images using a three-nucleotide Genetic Analyzer set. A complete set of three-nucleotide Genetic Analyzers used in this analysis is shown in FIG. 2A. The order of the Genetic Analyzers used is shown in FIG. 2B. FIG. 7A shows the flow of events in creating a Genetic Image for a retroviral element sequence for green grapes, cut with a full set of three-nucleotide Genetic Analyzers and in the order shown. The chart diagram is a visualization of the cut locations and resulting fragment sizes (similar to FIG. 2C). This data was then consolidated into a smaller dataset with only the fragment sizes sequentially listed by order of the cut; these fragment groups were then listed by order of the Genetic Analyzer utilized (dataset similar to FIG. 3C). This dataset can then be converted to a Genetic Image. A representation of a generated Genetic Image is then shown (similar to FIG. 4E). FIG. 7B is similar to 7A, but shows the resulting data from a retroviral element sequence from red grapes.

FIG. 8 is a representation of one embodiment of a computer system that can be used to implement the methods described herein.

### DETAILED DESCRIPTION

The disclosed invention generally relates to Genetic Images, methods of making Genetic Images, and methods of using Genetic Images to store, retrieve, and compare genetic sequence information. The invention includes new protocols to convert any genetic sequence (DNA and RNA), or an amino acid sequence, into a numeric data set that is then encoded to generate a Genetic Image. The Genetic Image can be traced backwards to determine the original genetic sequence information.

1. General Overview of Genetic Images

A Genetic Image is a representation of genetic sequence information, e.g., DNA or RNA, that can be analyzed, e.g., visually or by machine. The Genetic Image is a compressed and encoded form of a genetic sequence that takes far less storage space than the original sequence information, and can be easily analyzed and compared with other Genetic Images to easily detect differences between two different genetic sequences.

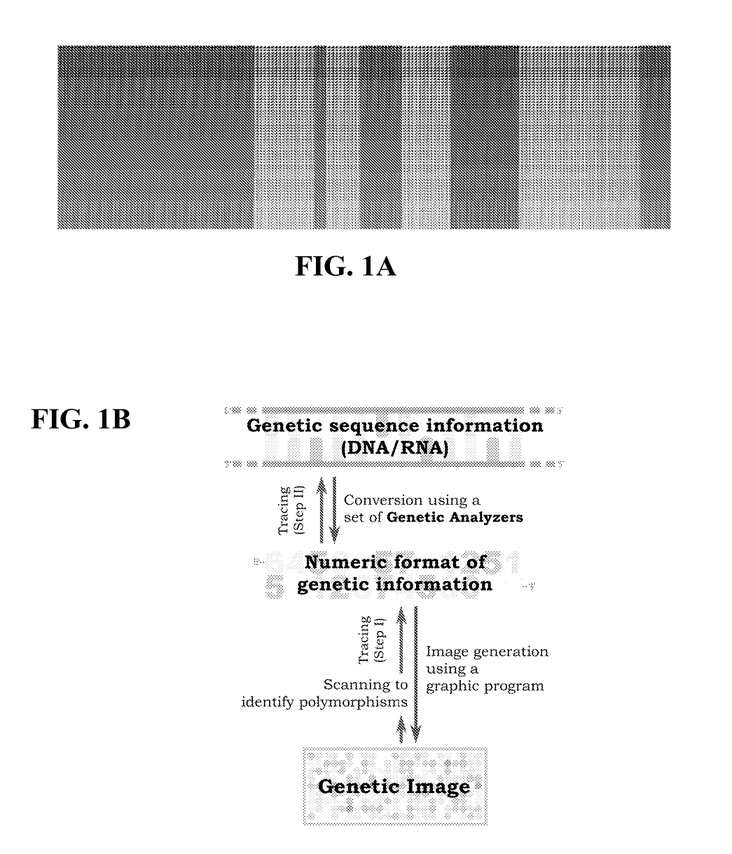

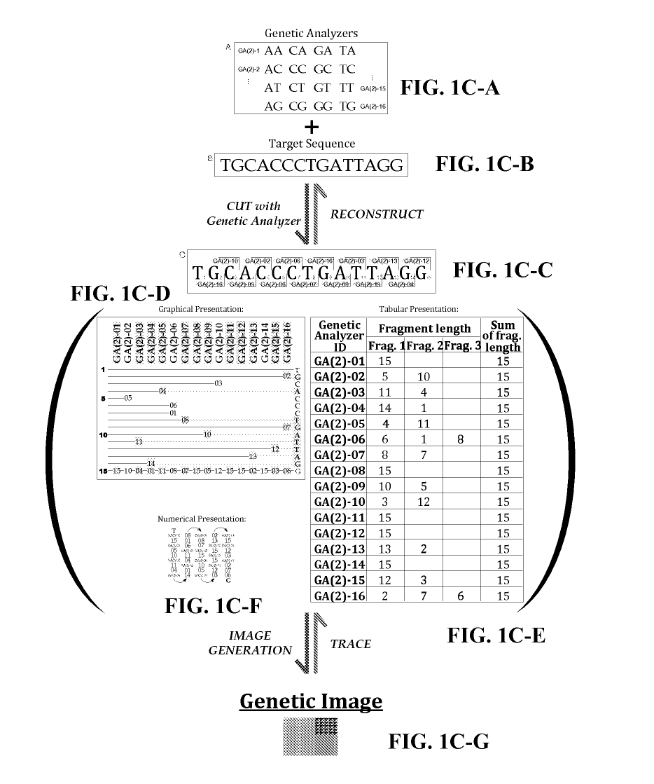

In various embodiments, the numeric data set that represents a specific genetic sequence (e.g., a sequence that contains a large amount of genetic information) can be encoded to form a Genetic Image that is represented in an image format such as JPEG, JPS (JPEG Stereo), PNG, or PNS (PNG Stereo). FIG. 1A shows one example of such a PNG Genetic Image. FIG. 1A is a representation of a Genetic Image in the form of a Portable Network Graphics (PNG) (1620×640 pixels) image that represents a set of retroviral elements identified from a sample of red grape genomic DNA using a series of different primers. Each data point represents the total number of fragments generated when a specific sequence is cut with a particular Genetic Analyzer. As described in further detail herein, these elements were cut with a set of 3-nucleotide Genetic Analyzers. The numbers of generated fragment sizes per Genetic Analyzer were arranged by Genetic Analyzer order and by primer set to create a dataset, which was processed by our cutEvolution software to generate the image. In certain embodiments the Genetic Images of small amounts of genetic sequence data can also be represented as two- or three- (or more) dimensional barcodes or bar graphs.

In other embodiments, the Genetic Image can be in the form of a hologram, a radio frequency identification (RFID) element, a solid-state memory element, a magnetic element, a magneto-optical element, an optical disc element, or the like. In general, the GA analysis of the sequence creates a dataset that is then processed to form a visualization of that data, or the Genetic Image. This is similar to any image, so you can store it on a flash drive or some other electronic media as well as print it on paper or other media. The image formats can also be represented electronically on a monitor or screen, such as on a computer monitor, a mobile telephone screen, or on a personal digital assistant (PDA) screen. In each case, the representation permits visual or optical analysis and comparison, e.g., with a laser scanner or image capture device, such as a charge-coupled device (CCD). Images on paper or other non-electronic media can be scanned, e.g., digitally, and then compared by machine. For example, these images can then be compared using standard pattern recognition software, such as fingerprint matching or facial recognition programs. Alternatively, the Genetic Images can also be analyzed and compared by computer in digital, electrical form without the need for a tangible printout or image represented on a computer or other screen or monitor.

In some embodiments, the sequence data can be encrypted. As used herein, “encrypted” sequence data has been transformed by a cipher algorithm so that the sequence data typically cannot be read or interpreted unless first decrypted with a corresponding cryptographic key. Some examples of encryption formats include, but are not limited to AES-256, RSA-256, and the like. However, the process described herein to create the Genetic Images already provides a very secure system, because the length and the cut location within the Genetic Analyzers, and the order of the Genetic Analyzer set used are all, in effect, “keys” that are required to read the Genetic Image. Also, the non-sequence data that might be stored together with the Genetic Image can also be encrypted using any standard encryption format.

The Genetic Images described herein may typically be used to indicate the correspondence of the data encoded thereon to some other object or subject, such as a patient file, a sample container, a patient ID bracelet, a tag that can be affixed to a test animal or the animal's cage, a shipping or customs label, a license, a permit, a security badge, a passkey, an entry ticket, a particular location or address, and the like. When the Genetic Image is represented on a label, it can be in the form of a pattern printed on or embedded in the surface of a sample container, an implanted tag on a person or an animal, and the like. The label can be an inert substrate that incorporates the sequence data as a pattern, e.g., as a printed code on adhesive backed paper, cloth, plastic, metal, or the like. The label can be a machine-rewriteable substrate, such as a magnetic strip or disk, a writeable digital video disc, or a radio frequency identification (RFID) tag. The label can also be a temporary physical embodiment of the encoded, machine-readable data, for example, as an image embodied in activated pixel elements, e.g., polarized liquid crystal pixels, light emitting diode pixels, electronic paper pixels, or the like, for example, as in a cell phone display or on a computer or other monitor. Sequence data can thereby be stored by incorporating the sequence data into the Genetic Image, and can be retrieved by reading and decoding the Genetic Image, for example, with a corresponding machine reader. Also, sequence data can be compared by, for example, visually comparing the encoded data, or by reading the encoded data into a corresponding machine reader and therein automatically comparing the data. In some embodiments, the encoded non-sequence data can be visually compared by a person while still leaving the sequence data encoded therein in non-human readable form. For example, sequence data can be encoded in an image that does not facilitate human readability of the sequence, but nevertheless, two images corresponding to same or different sequences may appear visually the same or distinct to a person viewing the two images.

2. General Overview of Methods of Generating Genetic Images with Genetic Analyzers

As shown in the flowchart of FIG. 1B, the invention includes the preparation and use of sets of so-called “Genetic Analyzers” (as described herein), each of which is capable of converting any genetic (e.g., nucleic acid or amino acid) or non-genetic sequence into a numeric format (referred to herein as a “numeric data set”) in silico, e.g., in a computer. In general, a Genetic Analyzer is an in silico representation of a restriction enzyme. Thus, a Genetic Analyzer is a representation of a specific sequence, e.g., a sequence of 3, 4, 5, 6, 7, or more nucleic acid representative letters (e.g., A, C, G, and T for DNA and A, C, G, and U for RNA), at which a longer nucleic acid sequence may be “cut” (e.g., separated) in silico. As described in further detail below, a set of Genetic Analyzers is generated and used to “cut” the genetic sequence to generate the numeric data set.

If the “sequence” is a non-genetic sequence, such as a sequence of letters, numbers, and/or symbols rather than nucleic acid or amino acid sequences, the Genetic Analyzers would then similarly include letters, numbers, or symbols, and not be to be limited to nucleic acid bases (ACGT) or amino acids. Note that each unique Genetic Analyzer in a set of Genetic Analyzers “cuts” the nucleotide sequence immediately after a segment of nucleotides that is identical to the sequence of the given Genetic Analyzer. Thus, a Genetic Analyzer AGG will be said to “cut” the nucleotide sequence, e.g., after every occurrence of the AGG segment within the nucleotide sequence. Of course, the cut site does not have to occur at the end of the Genetic Analyzer, but at any pre-specified location within its sequence. For example, the Genetic Analyzer could be defined to cut after each first nucleotide, so the Genetic Analyzer AGG would “cut” between the “A” and “G” at every occurrence of the AGG segment.

Once the numeric data set is created, it can be converted, using other software programs, into a Genetic Image, e.g., as shown schematically in FIG. 1B, and as an actual example of a PNG-based Genetic Image as shown in FIG. 1A. The process can also be run in reverse, to take a Genetic Image and trace it backwards to determine the original genetic sequence used to create the Genetic Image.

As discussed briefly above, in one example, a set of Genetic Analyzers is a group of all possible combinations of the corresponding nucleotides (A, C, G, and T/U) at each position of a certain Genetic Analyzer nucleotide sequence length (or amino acids at each position of a Genetic Analyzer of a certain length of amino acids). In principle, the Genetic Analyzer sequence length can range from one to infinity, but in practice, the length of a Genetic Analyzer typically ranges from two to a length of interest, for example, a length that results in a computationally useful number of Genetic Analyzers given the computer resources available and the length of the sequences to be converted into a Genetic Image. Thus, Genetic Analyzers for nucleotide sequences are typically 2, 3, 4, 5, 6, 7, 8, 9, or 10 nucleotides in length. One would use a shorter Genetic Analyzer, e.g., 3, 4, 5, or 6 nucleotides in length, to cut a shorter genetic sequence, such as up to about a thousand nucleotide bases in length; whereas one would use a longer Genetic Analyzer, e.g., 7 or 8 nucleotides in length, to cut a longer genetic sequence, e.g., up to about a million nucleotide bases in length.

For example, a complete set of in silico Genetic Analyzers for a nucleotide sequence length of one is A, C, G, and T (for DNA) and A, C, G, U (for RNA). Likewise, a complete set of in silico Genetic Analyzers for a DNA nucleotide sequence length of two includes each of the 16 possible two-base sequences based on the four bases A, C, G, T (for DNA) or A, C, G, U (for RNA). A complete set of Genetic Analyzers having a length of three nucleotides contains 64 Genetic Analyzers. Thus, in general, a complete set of in silico Genetic Analyzers includes a number of Genetic Analyzers equal to the number (X) of different units, e.g., nucleotide bases or amino acids (which is four for nucleotides and 20 for coded amino acids) raised to the power of the sequence length (n) of the Genetic Analyzers, e.g., Xⁿ.

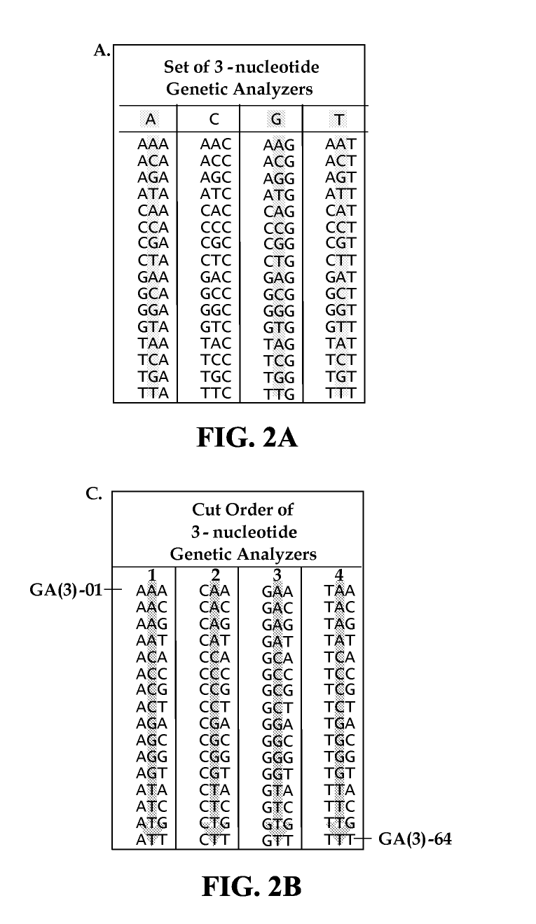

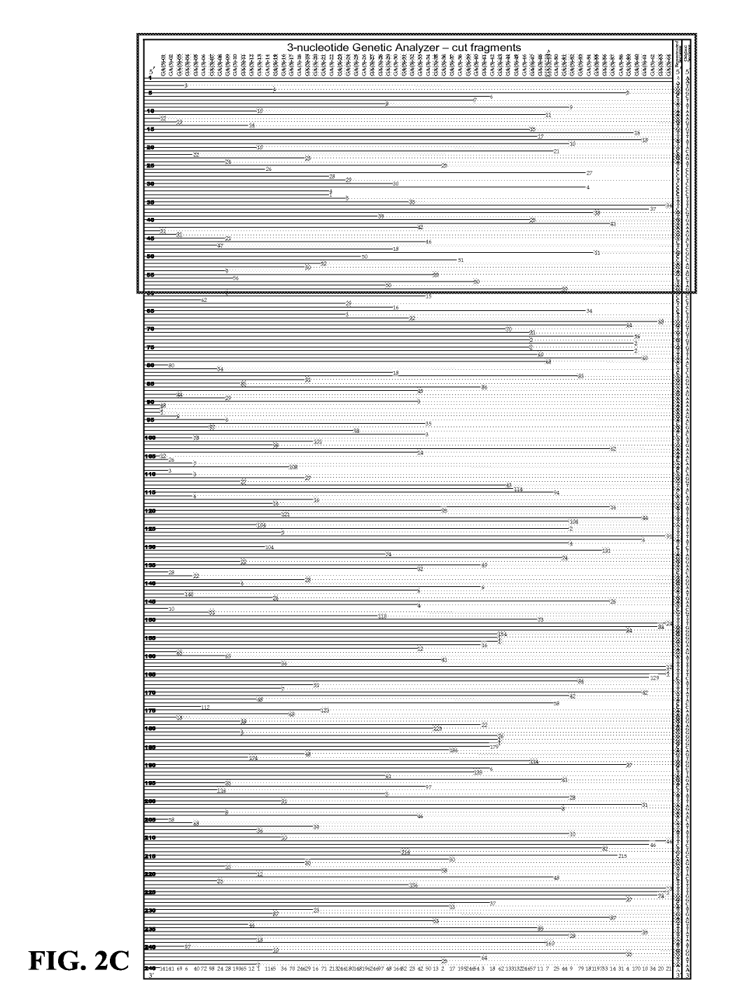

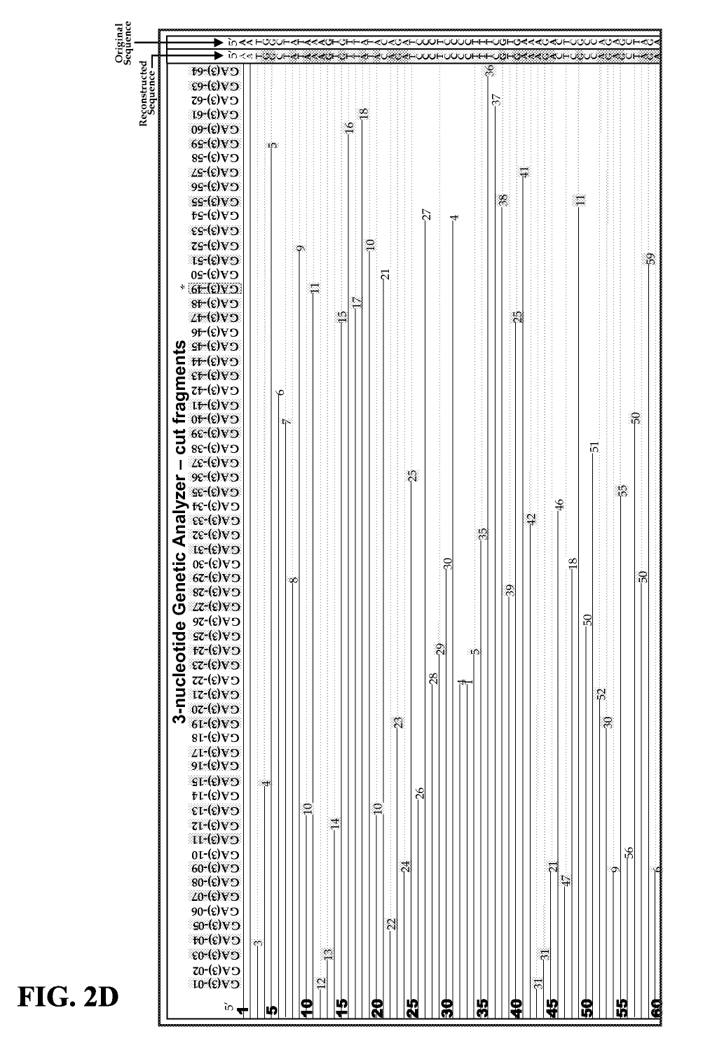

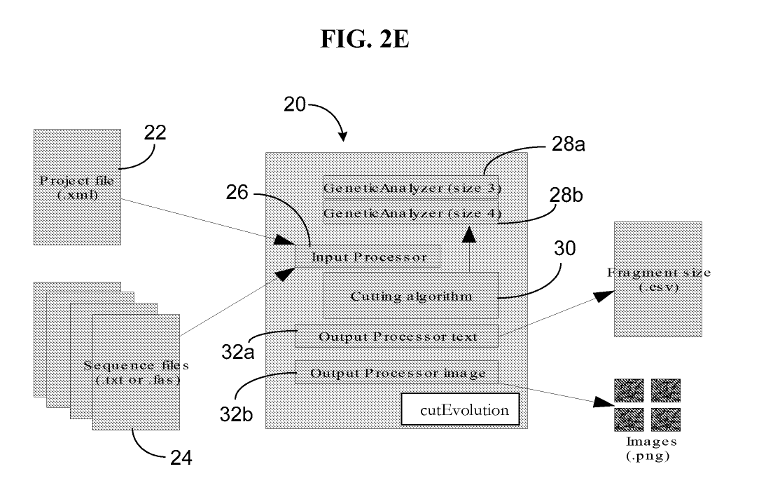

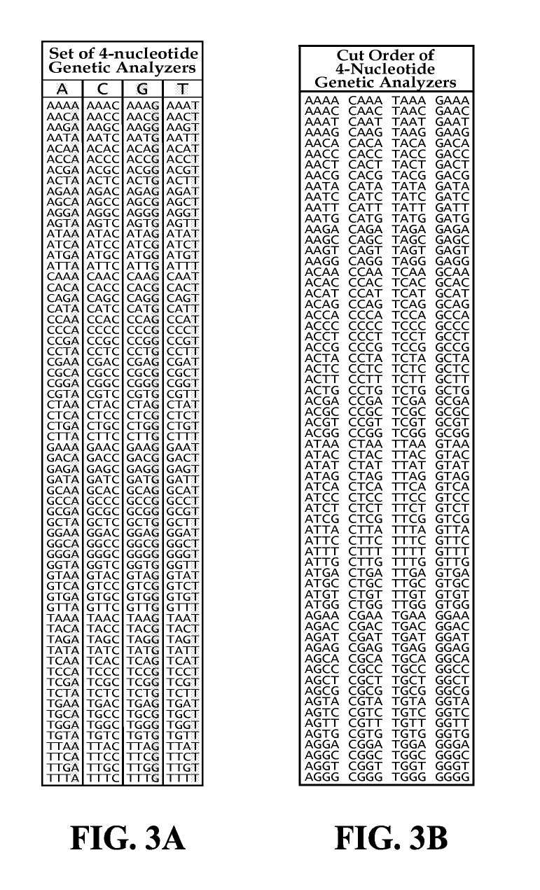

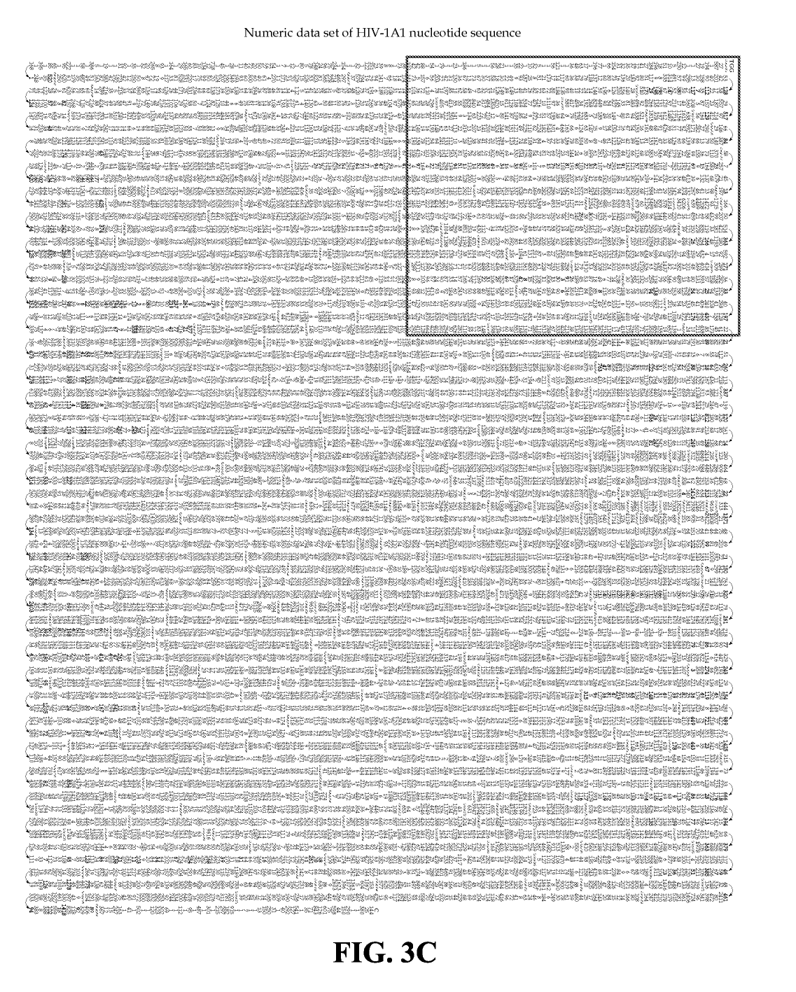

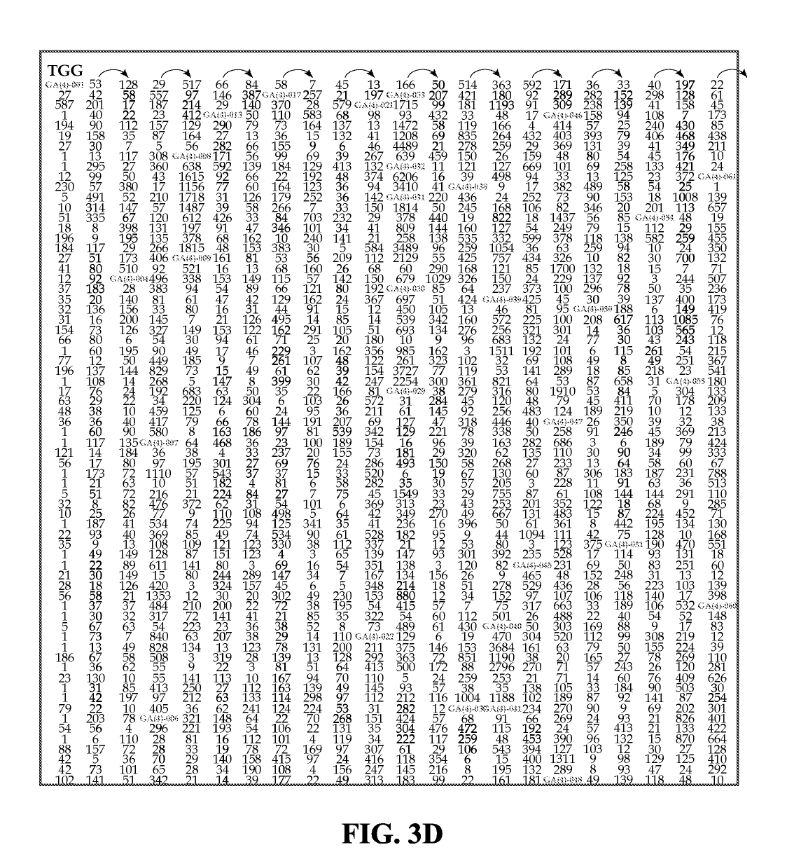

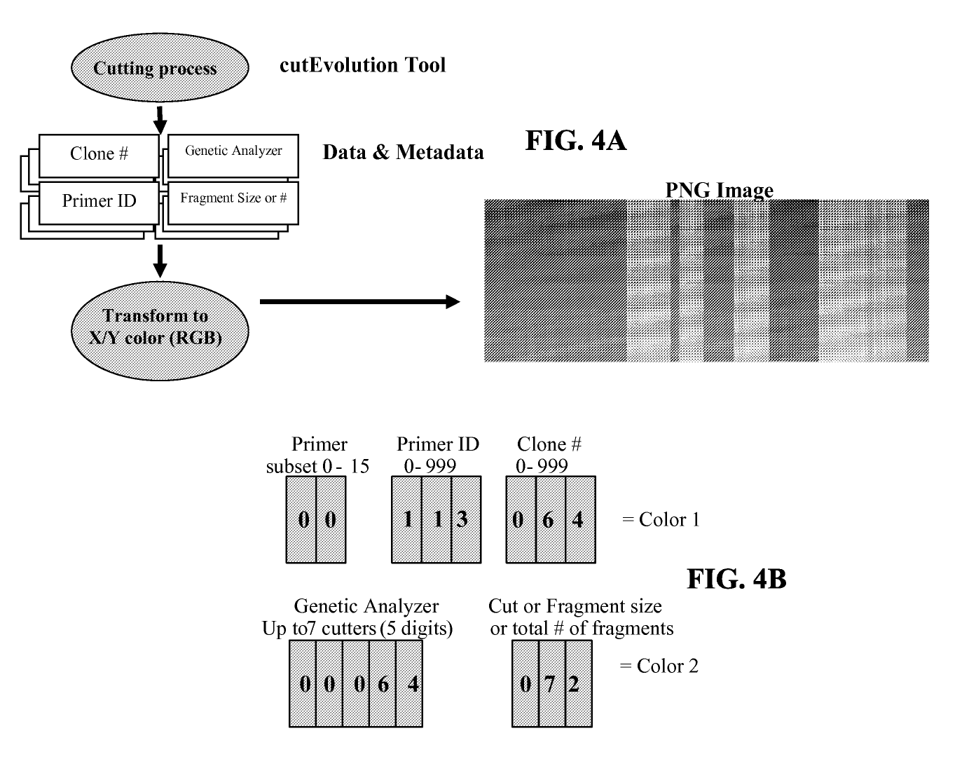

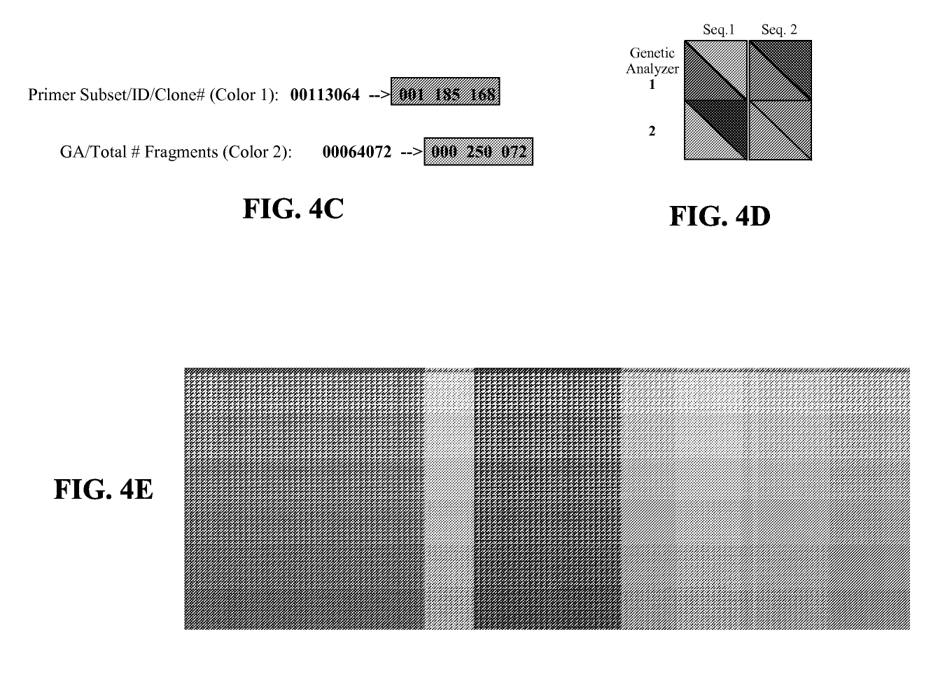

As an example, this equation would be 4³ for a set of Genetic Analyzers of 4 different nucleotide bases that are three nucleotides long=64 total Genetic Analyzers in the set (starting with AAA, AAC, . . . , and ending with TTT as shown in FIGS. 2A and 2C). In other examples, sets of 4-, 7-, and 8-nucleotide Genetic Analyzers are composed of 4⁴=256 members (AAAA, AAAC, . . . and ending with TTTT as shown in FIGS. 3A and 3B), 4⁷=16,384 members (AAAAAAA, AAAAAAC, . . . TTTTTTT), and 4⁸=65,536 members (AAAAAAAA, AAAAAAAC, . . . , TTTTTTTT), respectively.

In another example, the equation would be 20⁴ for a set of Genetic Analyzers of 20 different amino acids, where each Analyzer is four amino acids long=160,000 total Genetic Analyzers in the set. Note that the length of the Genetic Analyzers can impact the size of the final dataset. Furthermore, the total number of fragment sizes generated may have the greatest effect on the Genetic Image size.

“Cutting” a sequence with a full set of Genetic Analyzers in silico converts the sequence into an ordered and unique set of numbers, which is referred to herein as a numeric data set. Since the analysis is performed in silico, any nucleotides or amino acids can be used in the Genetic Analyzers, and epigenetic information can be captured as well. Thus, the genetic sequence information, including any polymorphisms, such as single nucleotide differences or epigenetic differences, can be converted into a numeric data set. Epigenetic information refers to factors besides DNA sequence that can influence the development of an organism. For example, in methylation, a methyl group is added to the carbon-5 position of cytosine, which usually occurs in CpG (cytosine followed by guanine) dinucleotides. This methylation subtly affects an organism in many ways, such as by stabilizing gene expression or suppressing viral genes. One method of discovering these methylation sites is to treat isolated DNA with bisulfite, which converts unmethylated cytosine residues into uracil residues, but leaves methylated cytosine residues unchanged. When the bisulfite treated DNA is sequenced, these basepair changes can be detected by comparison to non-bisulfite treated sequences. The two images (pre and post bisulfite treatment) can be compared to find the methylation sites. These methylation sites can then be noted on the sequence file and detected and/or analyzed using the Genetic Analyzers. For example, the Genetic Analyzers can capture the methylation status by including a new “methylated” base, so instead of only the bases of ACTG, there could be the new base “X” (which can be any letter or symbol), which represents a methylated cytosine residue.

The conversion of nucleotide sequence information into a numeric data set enables the use of high-resolution graphics programs (using available graphics formats, such as PNG, JPEG, or the like) to encode the numeric data set to create a Genetic Image, which is a compact, portable, scannable, and traceable format. The Genetic Images can be scanned, e.g., to identify polymorphisms among different genetic sequences from humans and other species including microorganisms and plants. Due to the ordered characteristics of the numeric data points in the Genetic Image, the genetic polymorphisms identified during the analysis, e.g., optical scanning, are traceable to the original nucleotide sequence data. This protocol, involving the numeric conversion of genetic sequences using the Genetic Analyzers and the generation of a Genetic Image, is an efficient tool to store any genetic information in a compact and portable format, as well as to compare and trace polymorphisms at the genome and expression levels.

3. Methods of Generating Genetic Analyzers

As noted, the Genetic Analyzers are part of a software program and can be thought of as DNA restriction enzymes in silico. However, there are differences compared to actual DNA restriction enzymes used in vitro. First, in contrast to the limited number of available in vitro DNA restriction enzymes and corresponding recognition sites, the unique design of the Genetic Analyzers allows recognition of all possible combinations of nucleotide sequences for the sequence length of interest. Second, the Genetic Analyzers can recognize RNA nucleotide sequences without conversion into a cDNA format. Third, the Genetic Analyzers can capture epigenetic information, e.g., based on methylation of cytosine. For example, as noted above, the Genetic Analyzers can detect the methylation status by including a new “methylated” base, represented by a new base “X,” which stands for the methylated cytosine. Fourth, the actual cut site on the genetic sequence corresponding to the individual Genetic Analyzers is typically at the end of the defined sequence of the Genetic Analyzer, e.g., after the fourth nucleotide in a four-nucleotide long Genetic Analyzer, or at some other specified point corresponding to a location between two nucleotides within the Genetic Analyzers.

To synthesize a set of Genetic Analyzers with a defined nucleotide sequence length, all potential combinations of four nucleotides (A, C, G, T/U) at each position are calculated using an algorithm, e.g., a macro program designed within the Microsoft® Excel® Visual Basic program. This implementation is computationally tractable on contemporary desktop computers for Genetic Analyzer lengths up to 10 nucleotides. To facilitate the creation of sets of Genetic Analyzers that have a longer sequence length, e.g., 11, 12, 13, 14, 15, or more nucleotides in length, the same algorithm can be implemented more efficiently in another program, such as Mathematica® or MatLab®, or directly in a language such as C/CC+, Java, or the like. Table 1 below shows an exemplary Microsoft® Excel® macro program for synthesizing Genetic Analyzer sets, e.g., having 7 nucleotides in each member of the Genetic Analyzer set.

TABLE 1
Exemplary Macro to Generate Genetic Analyzers

```
Sub RRSevenLetterMutations( )
    count = 1
    Column = 1
    Dim first As String
    Dim second As String
    Dim third As String
    Dim fourth As String
    Dim fifth As String
    Dim sixth As String
    Dim seventh As String
    For a = 1 To 4
    For b = 1 To 4
    For c = 1 To 4
    For d = 1 To 4
    For e = 1 To 4
    For f = 1 To 4
    For g = 1 To 4
    Call getASCII (first, a)
    Call getASCII (second, b)
    Call getASCII (third, c)
    Call getASCII (fourth, d)
    Call getASCII (fifth, e)
    Call getASCII (sixth, f)
    Call getASCII (seventh, g)
        Cells(count, Column) = first & second &
third & fourth & fifth & sixth & seventh
        count = count + 1
        If count >= 65537 Then
        Column = Column + 1
        count = 1
        End If
    Next
    Next
    Next
    Next
    Next
    Next
    Next
End Sub
Sub getASCII (ByRef result As String, ByVal count As Integer)
If count = 1 Then
result = “A”
End If
If count = 2 Then
result = “C”
End If
If count = 3 Then
result = “G”
End If
If count = 4 Then
result = “T”
End If
End Sub
```

Once the entire set of possible combinations of Genetic Analyzers is calculated, they are put into a desired order, and the order is stored in memory or a machine-readable storage device. The order can be, e.g., alphabetical (see, e.g., FIG. 2B), or all the Genetic Analyzers starting with A, then all starting with C, then all starting with T, and then all starting with G (see FIG. 3B), or any other order, as long as the order is stored for future use. The sets of Genetic Analyzers are included in the cutEvolution tool, while larger Genetic Analyzer combinations can be stored in the database management system, as described in further detail below. The set of Genetic Analyzers can also be stored on any tangible storage medium, such a disks or portable memory devices.

4. Converting Genetic Sequences into Numeric Data Sets

Once the set of Genetic Analyzers has been generated, they are applied as a cutting device in silico to a specific target genetic sequence to generate a unique profile of cut fragments (in the form of a set of numeric data indicating their position and size of each cut) for the individual target sequence. The Genetic Analyzers can be generated anew each time, or they can be generated once and stored in memory and used as needed. Note that the order of the Genetic Analyzers in a set can change, and so different orders may be used at different times (and the exact order must be known to read the corresponding Genetic Image). Exactly how this information is stored and where will depend on the software design and the specific type of analysis. The resulting numeric data set, which is composed of cut fragments from the target sequence, is unique and enables the generation of a high-resolution Genetic Image for clear and rapid identification of any genetic polymorphisms among the sequences being analyzed.

An entire nucleotide sequence (DNA or RNA), which is subjected to a conversion analysis, is cut with one full set of Genetic Analyzers (e.g., a set of three-nucleotide Genetic Analyzers with 64 members, or a set of four-nucleotide Genetic Analyzers with 256 members). The Genetic Analyzers may be organized, for example, in an order of four different groups during the cut process depending on their recognition specificity for the nucleotide (A, C, G, or T/U) in the last position. For example, FIGS. 2A and 3A show four different subsets of Genetic Analyzers for three- and four-nucleotide Genetic Analyzers, respectively. Each subset of three- or four-nucleotide Genetic Analyzers, consisting of 16 or 64 analyzers, respectively, is able to account for all positions of a specific nucleotide type (A, C, G, or T). For example, the subset “A” identifies all positions of the nucleotide “A” in the target sequence, because all cuts within the target sequence made by the Genetic Analyzers in this subset, by definition, must be after an “A”. The same is true for subsets C, G, and T, which show all the Genetic Analyzers that cut after these respective nucleotides.

The nucleotide sequence is cut with each Genetic Analyzer and the resulting cut fragments are recorded as a number (size of fragments) in the order of their positions from the 5′-end of the sequence. To convert the entire nucleotide sequence information into a numeric data set, all Genetic Analyzers in a set are utilized individually to cut the sequence. The numeric data set acquired from this conversion process (cutting) now contains information regarding the position and identity of every nucleotide in the sequence except for the few nucleotides on the 5′- and/or 3′-ends, depending on the set of Genetic Analyzers used.

The numeric data from each Genetic Analyzer, composed of ordered cut fragments, can be collected as a series of numbers in the order of the Genetic Analyzers utilized in this conversion process. The set and order of Genetic Analyzers is fixed during a cutting analysis of a sequence or group of sequences. The data set does need to be in a predetermined order so it can be analyzed or traced, but the actual Genetic Analyzer order can be altered from application to application, providing another level of security. The numbers are ordered because each set of Genetic Analyzers creates a set of ordered fragment sizes, or a list of fragment sizes in the order of appearance. Each group of fragment sizes is then ordered by the predetermined order of the set of Genetic Analyzers, which can be varied, but must be known to read the resulting Genetic Image.

To account for the 5′-end nucleotides, which are not recognized in a given set of Genetic Analyzers (e.g., the first three nucleotides if using 4-nucleotide set), their nucleotide identity (A, C, G, or T/U) can be entered at the beginning of the numeric data set without any additional conversion. In addition, the last nucleotide at the 3′-end, which is recognized by a Genetic Analyzer, but does not contribute to the generation of a relevant cut fragment (numeric data) due to its end location, can be attached to the end of the numeric data set. Thus, the final numerically converted sequence data set consists of: a few 5′-end nucleotides (variable depending on Genetic Analyzer set utilized)+a series of numbers (=size of cut fragments in the order of cut occurrence and Genetic Analyzers used)+one 3′-end nucleotide.

In the version of software described herein, there is only one end nucleotide that needs to be known, because when a sequence is cut with a Genetic Analyzer, that final fragment size will always be the length from the last cut site to the end of the sequence. For all the other fragments, you always know the last nucleotide of that fragment. It will be the same as the sequence of the Genetic Analyzer used. However, the end sequence of that last piece is unknown, because the end of it is not created by a cut. This will be true for all the last fragments for all Genetic Analyzers. However, there will always be a Genetic Analyzer that cuts at one base pair from the end of the sequence, creating a last fragment size of 1, so one can trace back all the other bases except that last one. To account for this, that last base and other important unchangeable information (the beginning n−1 bases, the GA size, and the GA order) need to be encoded directly into the data set to trace the Genetic Image back to the original sequence. Other variations of the software can eliminate the need for including the n−1 and last base data.

Alternatively, the cut fragment data from all Genetic Analyzers may be combined and reorganized as a number of cut fragments with same size. As a result, the numeric data set becomes more compact and still maintains the unique characteristics of the original nucleotide sequence for the generation of Genetic Image. In this embodiment, the information is ordered in a manner similar to a RFLP. Changes in the sequence are visible, because the total number of a certain fragment size(s) should change when cut with a full set of Genetic Analyzers. In this way, one can rapidly determine changes in sequence, and identify which sequences need to be studied or compared in more detail.

FIG. 1C-A to 1C-E illustrates the conversion of a hypothetical nucleotide sequence of fifteen nucleotides into a numeric data set using a set of two-nucleotide Genetic Analyzers. In this Example, a target nucleotide sequence (TGCACCCTGATTAGG; FIG. 1C-B) is subject to an analysis using a set of sixteen 2-nucleotide Genetic Analyzers (designated GA(2)-1 to GA(2)-16) and shown in FIG. 1C-A. Each unique Genetic Analyzer in the set recognizes specific position(s) on the target sequence as illustrated in FIG. 1C-C where the target sequence is aligned with the various Genetic Analyzers. For example, the Genetic Analyzer AA (GA(2)-1) is not represented at all in the target sequence, and so does not generate any cut. This creates a number “15” associated with this first Genetic Analyzer.

Genetic Analyzer AC (GA(2)-2) is represented once in the target sequence and so generates a cut just after its appearance in the target sequence, i.e., only after location 5. This creates two fragments, one that is five nucleotides long and the other that is ten nucleotides long. This creates two numbers “5” and “10” associated with this second Genetic Analyzer.

Most of the Genetic Analyzers cut once, in this example. Only Genetic Analyzers CC (GA(2)-6) and TG (GA(2)-16) cut twice. For example, the Genetic Analyzer TG cuts after location 2, and after location 9, thus creating three fragments that are two, seven, and six nucleotides long, respectively. Thus, this last Genetic Analyzer in the set, creates three numbers “2,” “7,” and “6” associated with this particular Genetic Analyzer.

Each recognition site creates an in-silico “cut” to generate a number representing the nucleotide length of the fragment created from individual Genetic Analyzers within the set. The numbers generated from these cut events (each associated with their specific Genetic Analyzers) are presented in a graphical presentation (FIG. 1C-D), a tabular presentation (FIG. 1C-E), and as a string of numbers (FIG. 1C-F). These numbers, each associated with their specific Genetic Analyzer, form a numeric data set that can then be encoded into a Genetic Image (FIG. 1C-G). The “graphical presentation” provides a visual link to how the numbers can be traced back to the original sequence. Because each number generated is unique in terms of position on the target sequence, the original sequence can be traced and reconstructed by knowing which GA generated (or corresponds to) which cut numbers. The generation of the Genetic Images is described in further detail below.

FIGS. 2A-2C illustrate the conversion of actual nucleotide sequence information into a numeric data set using a set of three-nucleotide Genetic Analyzers. A segment of the mouse mammary tumor virus (MMTV) superantigen endogenous retroviral sequence (246 nucleotides) was subjected to a cut analysis using an entire set of 3-nucleotide Genetic Analyzers. FIG. 2A shows four different subsets of three-nucleotide Genetic Analyzers indicated by the nucleotide in the third, or last, position (A, C, G, and T in the third/last position). Each subset of three-nucleotide Genetic Analyzers consists of 16 analyzers (that each has a specific one of the four possible nucleotides in the last position). FIG. 2B shows the same set of Genetic Analyzers, but in their cut order, starting with AAA, AAC, AAG, AAT, . . . and ending with TTA, TTC, TTG, and TTT.

FIG. 2C shows the resulting numeric data (size of cut fragments) listed sequentially by cut location on a scale of 1-246 (the total number of nucleotides in the target genetic sequence) for each Genetic Analyzer, so that the relative positions of each nucleotide can be readily identified. There are 64 possible 3-nucleotide Genetic Analyzers, which are identified as “GA(size of the GA)-cut order number.” These are arranged in order from GA(3)-01 to GA(3)-64 across the top of FIG. 2C when properly oriented. Different colors are used in this example to represent the end nucleotide (either A, C, G, T) of the GA used, so all GAs ending in A are one color, all ending in C another, so on. This color representation is used in this particular figure only to better visualize or highlight the end nucleotide when verifying the reconstruction of the sequence. Of course, gray-scale or other indications (such as font type or size) can be used to distinguish the end nucleotide, but this coloring or highlighting of the last nucleotide is, of course, not a required step in the process.

Numbers on the left vertical side of FIG. 2C in bold font represent the 246 nucleotide positions. The sequences on the right verticals are the reconstructed sequence (with colors) and the original sequence. Numbers under the Genetic Analyzer columns indicate the size of the fragment obtained when cut with that Genetic Analyzer. For instance, in the column under GA(3)-01, there is a 12 (with a line indicating that this occurs at position 12 on the left vertical ruler), 31 (at position 43), 48 (at position 91), 1 (at position 92), 1 (at position 93), 12 (at position 105), and 141 (at position 246). This information indicates that cutting the sequence with GA(3)-01 results in 7 fragments of 12, 31, 48, 1, 1, 12, and 141 nucleotides long (which can be checked since the total of all these fragment sizes should equal 246 bases). A close-up of the “box” shown in FIG. 2C is represented in FIG. 2D, for the first 60 of the 246 nucleotide positions.

The GA(3)-01 is colored blue, which indicates that this Genetic Analyzer ends in the letter T. To decode the sequence, there should then be a T at positions 12, 43, 91, 92, 93, and 105. The last fragment (at position 246) is not a fragment created by a cut, but by reaching the end of the nucleotide sequence and therefore is not used in reconstructing the original sequence. As shown along the right side of FIG. 2C (when properly oriented), the original nucleotide sequence can be reconstructed from the numeric data set of cut fragments. Since the first two nucleotides (5′-AA) are not recognized by any 3-nucleotide Genetic Analyzers, resulting in no relevant numeric data, they are added to the reconstructed sequence. In addition, although the very last nucleotide on the 3′-end (A) is recognized by a Genetic Analyzer (GA(3)-49[TAA], which is the meaning of the asterisk in FIG. 2C), this specific cut event does not generate a numeric data accounting for the last nucleotide. Thus, the last nucleotide (A) is added during the reconstruction from the numeric data set. The complete nucleotide sequence reconstructed from the numeric data set is confirmed to be identical to the original sequence, as shown along the right two lines of the figure

The fragment information in FIG. 2C can also be visualized as a numeric data set where only the beginning bases, fragment sizes, and end base are listed (such as the list of numbers represented in FIG. 3C, for an HIV-1A1 sequence, as discussed in further detail below). Only the fragment sizes are necessary, because the sequence position can be inferred from this series of numbers.

In general, the Genetic Analyzers are applied to a given genetic sequence using a sequence cutter tool software program, referred to herein as the “cutEvolution.” The cutEvolution tool is a program that reads amplified nucleotide sequence files and generates the numeric data set, which is a list of fragment sizes and/or total number of fragments generated for a given Genetic Analyzer. The location and name of the sequence files, the Genetic Analyzers to be used, and the output location and output type for the data are all defined in the cutEvolution project file. FIG. 2E shows a schematic representation of the basic modules of the cutEvolution software program 20. Input data is stored in Project File 22 and Sequence Files 24. The cutEvolution Project File 22 can be implemented in XML format, and contains definitions that are used by the Input Processor 26 of the cutEvolution software 20 to find input data, the parameters to run the tool, and the output location and output type (text or image). The Sequence Files 24 include the genetic sequence information, e.g., the nucleotide or amino acid sequences to be analyzed and converted into Genetic Images.

The cutEvolution software 20 includes one or more sets of Genetic Analyzers (for example, in FIG. 2E, a set of all 3-nucleotide Genetic Analyzers (28a) and a set of all 4-nucleotide Genetic Analyzers are included) (28b) that are stored in a machine-readable memory. Of course, other sizes of Genetic Analyzers can be included as needed. The program also includes a so-called Input Processor module 26, a Cutting Algorithm module 30, and an Output Processor Text module 32a and an Output Processor Image module 32b.

The amplified nucleotide sequences and the Genetic Analyzers are read by the cutEvolution Input Processor module 26. Small specific sequences of DNA (Primer Set) matching the ends of a DNA sequence of interest can be used for PCR amplification of that region. However, in other applications, obtaining the sequence to be analyzed by a set of Genetic Analyzers does not have to be done by using primer sets and PCR. The following process is applied for all amplified nucleotide sequences input into the application:

1. The sequence is loaded and scanned for occurrences for each Genetic Analyzer in the list (64 Genetic Analyzers for 3 cutters, 256 Genetic Analyzers for 4 cutters, etc.).

2. For each match the fragment size is calculated as follows:

([Current Cutting Position]+[Size of Genetic Analyzer])−[Previous Cutting Position]

Exceptions are as follows:

1. At the beginning of each sequence scan, the [Previous Cutting Position] is set to 0.

2. If no match is found the fragment size is set to the sequence length of the original sequence.

3. The remainder of the sequence after the last match is the last fragment size.

The fragment sizes are written out in a specified serial order for each Genetic Analyzer and the order of the Genetic Analyzers are kept constant through the analysis for the selected sequence file.

In a specific embodiment, the output format can be comma separated values (csv), which can be easily imported to spreadsheets and other programs. In this embodiment, the output is organized in columns that represent the sequence ID (such as the subject ID, primer set ID, clone #) and rows that represent the Genetic Analyzers. In general, the data output can be organized in various arrangements, such as having the columns represent the sequence ID, and the rows representing the Genetic Analyzer set.

FIGS. 3A-3D illustrate the conversion protocol, in which the entire genomic sequence of an HIV-1 (human immunodeficiency virus-1) strain was converted to a numeric data format by cutting with a full set of four-nucleotide Genetic Analyzers. The conversion process was finalized by adding three nucleotides at the beginning and one nucleotide at the end of a sequential numeric data set for the HIV genomic sequence analyzed. The resulting numeric profile of cut fragments in both size and position from this genomic sequence ultimately depicts the original sequence information.

FIGS. 3B and 3C show the conversion of an HIV-1 nucleotide sequence into a numeric data set using an entire set of four-nucleotide Genetic Analyzers. The nucleotide sequences of HIV-1A1 (accession no. AB098331; FIG. 3C) was retrieved from the HIV sequence database (internet address hiv.lanl.gov) and converted into a numeric data set by cutting the sequences with an entire set of four-nucleotide Genetic Analyzers (256 total, listed in a FIG. 3A and listed in cut order in FIG. 3B (starting with AAAA and ending with GGGG). The size of cut fragments was sequentially arranged by cut order for each Genetic Analyzer and the numeric data points from all 256 Genetic Analyzers (identified as GA(4)-001 to GA(4)-256), representing cut fragments, were arranged in the order of the Genetic Analyzers employed. These numeric data sets are ready for import to generate a Genetic Image, as described in further detail below.

FIG. 3C shows the complete numeric data set starting in the upper left corner with TGG. The first fragment generated (which also infers the first occurrence of the Genetic Analyzer GA(4)-001) is 27 nucleotides long, while the next fragment (which infers the next occurrence of the GA(4)-001 sequence) is 587 nucleotides long (i.e., this next “cut” occurs 587 nucleotides after the first occurrence of the GA(4)-001 sequence). The numeric data set fragment size numbers for the first Genetic Analyzer (GA(4)-001) continue on: 27, 587, 1, 194, 19, 27, 1, 1, etc. The numeric data set continues on for each Genetic Analyzer in cut order (GA(4)-002, GA(4)-003, etc.), which are interspersed between the fragment size numbers. The overall set of numbers ends in the middle of the right side of FIG. 3C at . . . , 1, 1, 380, 25, 144, C.

FIG. 3C includes a section of information surrounded by a “box.” This box is enlarged in FIG. 3D for ease of review. Note that FIGS. 2C and 3C give a general idea of the data. For example, FIGS. 2C and 2D are used to visualize how the cutting of the sequence occurs and how the fragments are created. On the other hand, FIGS. 3C and 3D provide an example of how data in a tabular form (e.g., as shown in FIG. 2C for a different example) can be summarized and put into a numeric data set in the form of a long numeric string. FIGS. 3C and 3D also illustrate just how much data is put in the Genetic Image.

In this numeric data set, the first three letters (TGG) represent the first three nucleotides not cut by any four-nucleotide Genetic Analyzer, then a series of numbers (which each indicate the fragment sizes for a given Genetic Analyzer, e.g., AAAA cuts at fragment sizes (which relate to the cut position), which are in this example 27, 587, 1, 194, etc.), and then ends with C, which is a single nucleotide at the end of the original genetic sequence.

5. Encoding a Numeric Data Set to Generate a Genetic Image

The genetic sequence information, entirely converted into numeric data using a set of Genetic Analyzers as described above, can then be encoded to generate a unique Genetic Image. The numeric data set is encoded as a graphic image in the order of the cut events/fragments for each Genetic Analyzer to ensure the uniqueness of cut profiles for each sequence analyzed. Thus, the Genetic Images are encrypted, compressed versions of the numeric data sets.

Alternatively, reorganized data made by combining the cut fragment profiles from all Genetic Analyzers may be encoded to form a Genetic Image. In addition, encoding multiple versions of the numeric data set (created by using different sets of Genetic Analyzers) from the same nucleotide sequence may enhance the accuracy of the scanning results. The Genetic Image is compact for storage and presentation, portable, and can be tangibly incorporated into a label, etc. as discussed herein. The individual numeric data points in the Genetic Image are scannable for comparison analysis and tracing of the original sequence information.

The numeric conversion of the nucleotide sequence information enables the use of a high-resolution graphics program to present the complex sequence information in a compact and portable format. The numeric sequence information is encoded to a scannable and traceable Genetic Image using a program, e.g., as described in further detail below. A Genetic Image can be created in any of a variety of available formats, e.g., JPEG/PNG/GIF or the like. For example, a Genetic Image can be generated as a heat diagram in a PNG format (see, e.g., the World Wide Web at libpng.org).

Two exemplary types of Genetic Images can be generated from the fragment data of nucleotide sequences, which are calculated using the cutEvolution software tool. In both types of images, only one set of Genetic Analyzers are used. Multiple Genetic Images can be grouped together to create a larger image with more information, if necessary.

1. Fragment Blocks Image (FBI)—In this type of image, only information about the total number of generated fragments for multiple sequences are color-coded. These images use two colors: one to identify the sequence and the other to identify the total number of generated fragments by a specific Genetic Analyzer. The FBI uses the two-dimensional (X and Y) axis for organization, with the sequences listed on one axis and the Genetic Analyzer on the other.

2. Fragment Row Image (FRI)—In this type of image, information about the size and order of each generated fragment for one sequence is color-coded. This image also uses two colors: one to identify the sequence and the other to identify the fragment size. The FRI uses the two dimensional (X and Y) axis for organization, with the Genetic Analyzer listed on one axis and the cut/fragment number on the other.

Both the FBI and FRI images can be implemented in standard Portable Network Graphics (PNG) files. Programming libraries are used to create the Genetic Image by utilizing the Genetic Analyzer dataset to determine the correct color blocks and positions within the Genetic Image, and verifying the color from a predefined color map to guarantee consistency. The color data assignment, the block size, and/or the data organization within the Genetic Image can be modified to include other information, depending on the type of data to be stored.

To store a large amount of data and still be able to rebuild the original sequence, the data should be compressed, such as in a compressed binary storage media. The cutEvolution tool includes an Output Processor module to generate images, e.g., in the PNG format. The Output Processor Image module of the cutEvolution creates images that satisfy the following requirements:

1. The sequence data must be compressed so that comparisons between such large data sets can be done efficiently.

2. The Genetic Image must enable one to trace back to a specific location in the original sequence from any position in the image. This allows one to trace back to the original sequence when comparing two images.

3. The Genetic Image must also enable one to reconstruct the entire original sequence from Genetic Image.

Genetic Images are created based on the order of the Genetic Analyzers used in the cutting process discussed above. For example, in a simple FBI PNG-based image, each column represents the sequence and each row a specific Genetic Analyzer. With this type of alignment, any data point (represented, e.g., as x and y coordinates, and color) in the Genetic Image can be tracked back to the sequence and the Genetic Analyzer. This simple alignment organization can be modified depending on the complexity and purpose of the Genetic Image. The color of the data point is used to encode detail information, such as the Primer ID, Clone number, Genetic Analyzer used and Fragment information.

The creation of a FBI is shown in FIGS. 4A and 4B, using a set of retroviral element sequences (each sequence is identified by a Clone number) obtained by PCR amplification (using various primer sets) of genomic grape DNA from wine samples. The Genetic Images are created using the process outlined in the flowchart of FIG. 4A, which shows that the process begins with the “cutting” process described above using the cutEvolution software program. The program generates a set of Data and Metadata in the form of a list of numbers that represent pertinent information, such as in this example, the Clone number, the Primer ID number, the Genetic Analyzer, and the number of fragments. In this specific example, the sequence data is actually not one sequence, but a series of different sequences of different retroelements. These sequences were obtaining by PCR using different primer sets (Primer ID number). There may be various sequences obtained from the same primer set, so to further differentiate exactly which sequence was obtained from a primer set, we add the clone number. This set of numbers is transformed into a Genetic Image, e.g., into an x, y, color RGB format, which is then represented as a PNG image.

The RGB color scheme uses a mixture of Red/Green/Blue in which each color allows 256 shade combinations. RGB provides a total of 256³ combinations of colors, which equals 16,777,216 unique colors. The data generated by the cutter algorithm needs to be mapped into numerical values that do not exceed the maximum combination of RGB color variations. Because the data for a subject is large and most likely creates hundreds of primers and sequence combinations, the 256³ combinations are typically not enough to store the information adequately. For this reason each data point can be represented in two colors using the data alignment (max values in boxes) shown in FIG. 4B.

In FIG. 4B, the sequence identification is composed of the Primer subset (which includes numbers 0-15), the Primer ID (which includes numbers 0-999), and the Clone number (which includes numbers 0-999), for a total of 8 digits that are used to generate Color 1. Color 2 is generated with five digits that correspond to the Genetic Analyzer identification number, which is enough for a 7-nucleotide Genetic Analyzer set, and three digits for the Fragment number (numbers 0-999). As shown in FIG. 4C, the numerical value for each data point, aligned as described above, is transformed into RGB color by converting the decimal value into a base 256 number. For example, the numbers for the Primer-Clone pair (Color 1), e.g., 00113064 would be the base 256 number 001 185 168. The numbers for the Genetic Analyzer and Fragment number pair (Color 2), e.g., 00064072, would be the base 256 number 000 250 072.

As shown in FIG. 4D, each data point in the final PNG-based Genetic Image is represented as a box of 10×10 pixels (which can be variable for higher compression) and the two colors (as determined by conversion of the data such as in FIG. 4C) are drawn as shown in the figure. FIG. 4D shows a close-up view to illustrate the two-dimensional organization of four data blocks within the final Genetic Image. In this example, a set of 3 nucleotide Genetic Analyzers was used to cut multiple sequences and only the total number of fragments was coded, so the Genetic Image was organized such that each column represents one sequence, and each row represents a single Genetic Analyzer. FIG. 4D shows only a portion of the Genetic Image that corresponds to two Genetic Analyzers.

FIG. 4E illustrates a PNG-based Genetic Image. In particular, FIG. 4E shows a 1440×640 pixel representation of a total number of fragments generated for a group of retroviral element sequences cut with a set of Genetic Analyzers similar to FIG. 1A, but for a white wine sample.

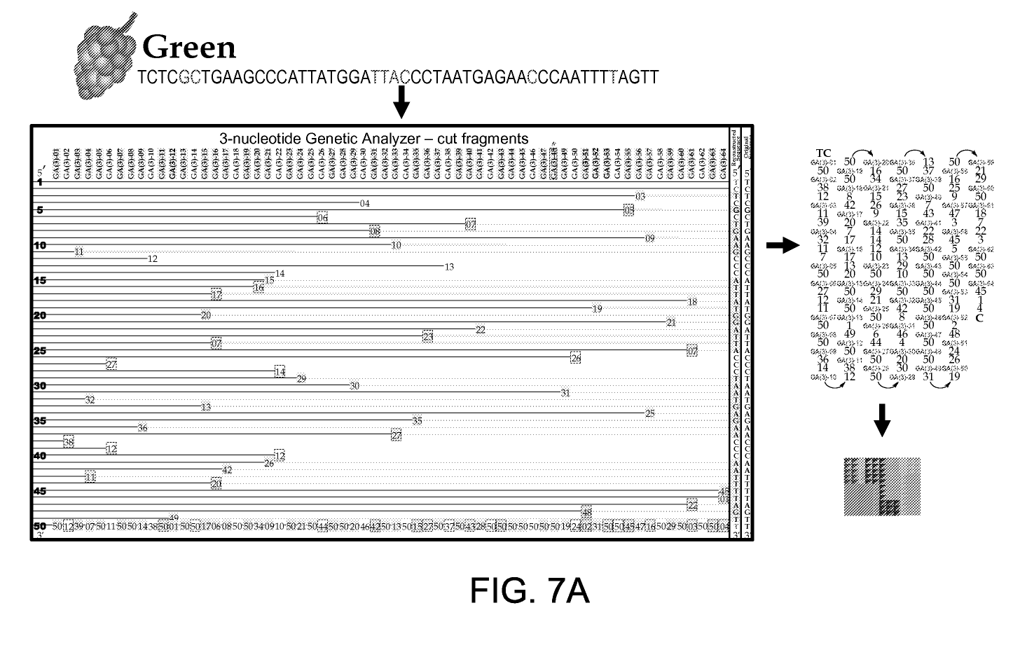

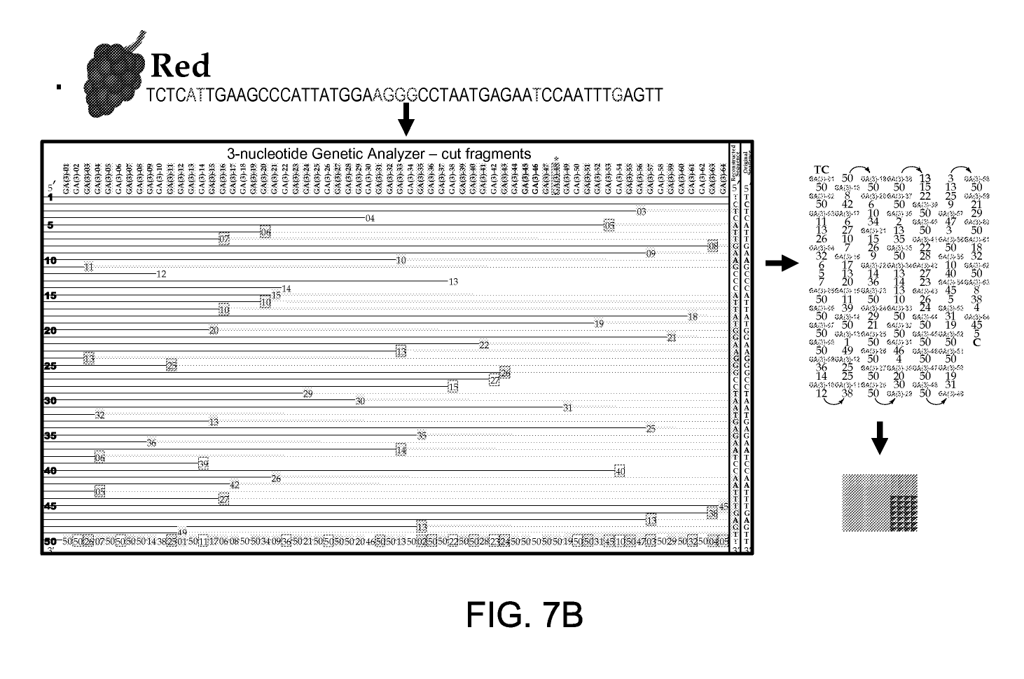

FIGS. 7A and 7B each show a series of images similar to FIGS. 2C, 3C, and 1A. These series of images represent the conversion of two short retroviral element sequences (one from green grapes, FIG. 7A, and one from red grapes, FIG. 7B) into Genetic Images using a three-nucleotide Genetic Analyzer set. A complete set of three-nucleotide Genetic Analyzers used in this analysis is shown in FIG. 2A. The order of the Genetic Analyzers used is shown in FIG. 2B. FIG. 7A shows the flow of events in creating a Genetic Image for a retroviral element sequence for green grapes, cut with a full set of three-nucleotide Genetic Analyzers and in the order shown. The chart diagram is a visualization of the cut locations and resulting fragment sizes (similar to FIG. 2C). This data was then consolidated into a smaller dataset with only the fragment sizes sequentially listed by order of the cut; these fragment groups were then listed by order of the Genetic Analyzer utilized (dataset similar to FIG. 3C). This dataset can then be converted to a Genetic Image. A representation of a generated Genetic Image is shown (similar to FIG. 4E). FIG. 7B is similar to 7A, but shows the resulting data from a retroviral element sequence from red grapes.

6. Comparison and Decoding of Genetic Images

The basic methods of decoding and reading a Genetic Image, e.g., on a label, card, or electronic screen, include the steps of providing a Genetic Image, reading and decoding the Genetic Image to generate the corresponding numeric data set, and applying a known set of Genetic Analyzers to obtain the original corresponding genetic sequence. The same basic steps are used if the Genetic Image is represented on an electronic screen, e.g., of a mobile telephone, PDA, or similar device. The decoding step is generally a reversal of the encoding step described herein.

In addition, two or more of the Genetic Images generated from two or more different nucleotide sequences can be compared to identify differences, e.g., polymorphisms, by scanning and overlaying the images on a computer or other monitor, or on other tangible objects, such as labels, paper, or plastic media. The Genetic Images, which are generated using a standard image format such as PNG or JPEG, can be scanned optically using any high resolution graphics or image scanner, e.g., a flatbed scanner or passport scanner. By overlaying the Genetic Images derived from different sequences, any mismatches/polymorphisms are highlighted and subsequently the relevant code(s) derived from the numeric data point(s) can be easily identified.

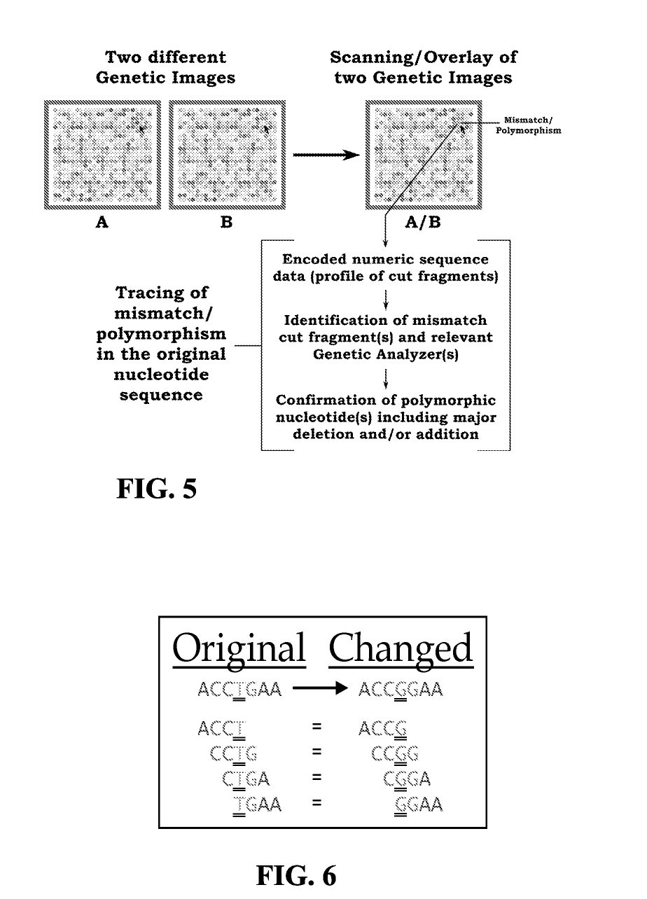

The mismatches/polymorphisms present in different Genetic Images are directly linked to differences or polymorphisms in the sequence data. For example, FIG. 5 shows a schematic overview for tracing a polymorphism identified in a comparison of two Genetic Images back to the original nucleotide sequence used to create the Genetic Images. The flow diagram explains how the polymorphisms, identified by scanning and overlaying of two different Genetic Images (A and B), are traced to the polymorphic nucleotide sequence by steps that include scanning and comparing, e.g., by overlaying, two Genetic Images, analyzing the encoded numeric sequence data (e.g., by analyzing the profile of cut fragments), identifying mismatches in the cut fragments(s) and relevant Genetic Analyzers, and confirming any polymorphic nucleotide(s) including major deletions and/or additions.

Each Genetic Image can be a tangible label that incorporates a machine-readable, encoded numeric data set (that corresponds to the genetic sequence data of a first specific biopolymer). In some embodiments, the Genetic Images can be configured so that the corresponding similarity or difference between the first and second sequences can be identified visually, e.g., by a human operator, or alternatively by machine. For example, in some embodiments, differences in the high-resolution Genetic Images can be discernable by human visual examination when there are colors and patterns within the images that are visible to the human eye. To facilitate such comparison, for example, Genetic Images can be incorporated into a semi-transparent material, allowing overlaid images to be compared to discern areas of overlap or difference. In addition, multiple analyses of data images of a single nucleotide sequence created using different sets of Genetic Analyzers can also assure the robustness of the scanned data. However, in practice it is far more practical to compare different Genetic Images by machine, because the differences between sets of data are typically too difficult to visualize by the human eye.

The following two factors can help trace the polymorphisms identified during the comparison of different Genetic Images to the original nucleotide sequences. First, the numeric sequence data generated by cutting with an entire set of Genetic Analyzers are capable of accounting for every single nucleotide on the original sequence by design. Second, the encoding system, which is used to create an ordered numeric data set of cut fragments to generate a Genetic Image, is designed to preserve the uniqueness/identification of the original nucleotide sequences analyzed.

The Genetic Images (or the underlying numeric data sets) can also be analyzed and compared within a computer, e.g., by analyzing the Genetic Images without ever printing or applying them to a tangible medium, or otherwise representing the Genetic Images on a monitor or screen. Thus, a plurality of data files representing Genetic Images can be compared by computer without the need for human visualization, though the images can be compared by computer while also being represented on a computer monitor.

As noted above, FIG. 5 shows a concrete example of a comparison of two Genetic Images, A and B, in which a specific mismatch between the two images is determined, e.g., by visual inspection or by computer comparison. Thereafter, the polymorphism giving rise to the mismatch can be tracked to changes in multiple cut fragments, depending on the number of mismatches. In fact, one nucleotide mismatch against the reference sequence can yield a cascade of alterations (removal and addition) in the recognition sites for Genetic Analyzers relevant to that region depending on their length.

For example, FIG. 6 shows a single nucleotide polymorphism, and resulting alterations in multiple recognition sites for Genetic Analyzers and relevant cut fragment profile. For the four-nucleotide Genetic Analyzers, a single nucleotide polymorphism (a change of a T to a G) results in the removal or addition of recognition sites for four Genetic Analyzers (ACCT to ACCG, CCTG to CCGG, CTGA to CGGA, and TGAA to GGAA). As a result, there are changes in 24 numeric data points. In particular, the removal of the recognition site for one Genetic Analyzer results in removal of two cut fragments and addition of one cut fragment (providing changes in three data points), and addition of the recognition site for another Genetic Analyzer removes one cut fragment and adds two cut fragments (providing changes in another three data points, for a total of six data points per Genetic Analyzer, and 24 changes for four Genetic Analyzers).

As a result, amplification of a single nucleotide polymorphism into a number of changes in numeric data points should contribute to enhanced visual readability as well as accuracy of such Genetic Image comparisons. Subsequently, a brief survey of the profile of cut fragments surrounding the highlighted/mismatch fragments and respective Genetic Analyzers identifies the mismatch nucleotide(s) precisely, including any major deletion and/or addition. If confirmation of the polymorphisms identified during this tracing process is needed, a selective segment of nucleotide sequences encompassing the polymorphic locus can be subjected to an alignment analysis.

An image analysis program can be created that can scan the coded data and track the polymorphisms. Since the Genetic Image can be a physical representation of the sequence data (RFLP or full sequence), any polymorphisms can be rendered visible as a change to the image pattern; a program to track and analyze the changes can be created or adapted from existing technologies. Even if the sequence data is encrypted, pattern changes can still be analyzable, even human-viewable, allowing researchers to conduct blind studies. An application of this image analysis program in genomics would be the ability to scan and detect single nucleotide polymorphisms (SNPs) within a number of large sequences which are encoded into the Genetic Images. Since the images would be relatively small (compared to the complete sequence listing), many sequences can be compared quickly and accurately, without the need to download or store large sequence files for analysis.

7. Physical and Electronic Genetic Images and Uses Thereof

As noted above, the new Genetic Images can take physical form on any number of substrates including paper, cardboard, plastic sheeting and films, metal, ceramic, and other materials. The Genetic Image can be printed, engraved, e.g., by laser, embossed, or otherwise applied, without limitation, to the substrate. In addition the nature of the substrate onto which the Genetic Image is applied can take many shapes, and be in the form or any number of different objects. For example, the substrate can be part of, or take the form of, a small plastic card, such as a credit card or driver's license. The substrate can be the wall of a container, or a label attached to a container, e.g., a medicine vial. The substrate can be part of a surface of, or a label attached to, any object that needs a specific identification.

The Genetic Images can also be represented electronically and/or optically, e.g., on a computer monitor or on the screen of a television, a mobile telephone, or a personal digital assistant (PDA), or any other similar device that includes a screen that can exhibit the Genetic Images. These electronic/optical representations of the Genetic Images can be presented temporarily, while they are being analyzed, scanned, and/or compared with other Genetic Images, and can then be deleted from the monitor or screen. Of course, a Genetic Image can be stored in a machine-readable form, e.g., as the numeric data set or as the Genetic Image itself, e.g., as a PDF.

Thus, the new Genetic Images can be placed on personal identification cards, e.g., along with name, address, and/or other information. In other words, the new Genetic Images can be used as a “Universal ID” code, in which each Genetic Image represents a unique genomic sequence data, e.g., based on individual subject's genetic material. Typically, subjects may be randomly assigned with identification numbers for various reasons, such as a social security number, a driver's license number, a patient ID number, and the like. A patient can even accumulate multiple ID numbers within a single medical network, such as one when he visits his regular physician and another if he is rushed to the emergency room for immediate care. If the patient transfers to a different medical network, he can be assigned even more ID numbers. On the other hand, a “Universal ID” can be, first of all, unique and specific, and can be valid no matter where the person may be located. Further, since the “Universal ID” can be based on encrypted sequence data, privacy of the patient's genomic data can be maintained. Similarly, such a “Universal ID” code can be established for forensic purposes, phylogenetic studies, animal experiments, regulatory or safety monitoring of foods, organisms, and other biological products, monitoring of endangered species, monitoring of synthetic sequence data or DNA identification tags, or the like.

The Genetic Image when used as a “Universal ID” can also be represented on the screen of a mobile telephone or PDA or other similar device, whenever needed, e.g., to gain access to a building (such a court house or school), pass through an identification checkpoint, enter an airplane or other secure vehicle or location, make a purchase with a credit card that requires the identification of the cardholder (e.g., at automated gasoline pumps and other automated payment systems).

The new Genetic Images can be used in any situation in which an identification of a person, animal, plant, or micro-organism is required. For example, the Genetic Images can be used in commerce, e.g., on foodstuffs (packaging) and agricultural products, e.g., to confirm that a particular vegetable, fruit (e.g., grapes, apples, or oranges), fish (e.g., tuna for sushi), meat (e.g., Japanese Kobe beef), or processed food or beverage (such as a cheese or a wine) is in fact what it is alleged to be.

8. Error Checking of Genetic Images

The application of a second set of Genetic Analyzers to the same target genetic sequence can be used as an elegant method of error checking of a resulting numeric data set and of the encoded Genetic Images. If the second set of Genetic Analyzers provides a numeric data set (and Genetic Image) that can be reconstructed to provide the same original genetic sequence, then one can be assured that the system has worked properly.

9. Hardware and Software Implementations

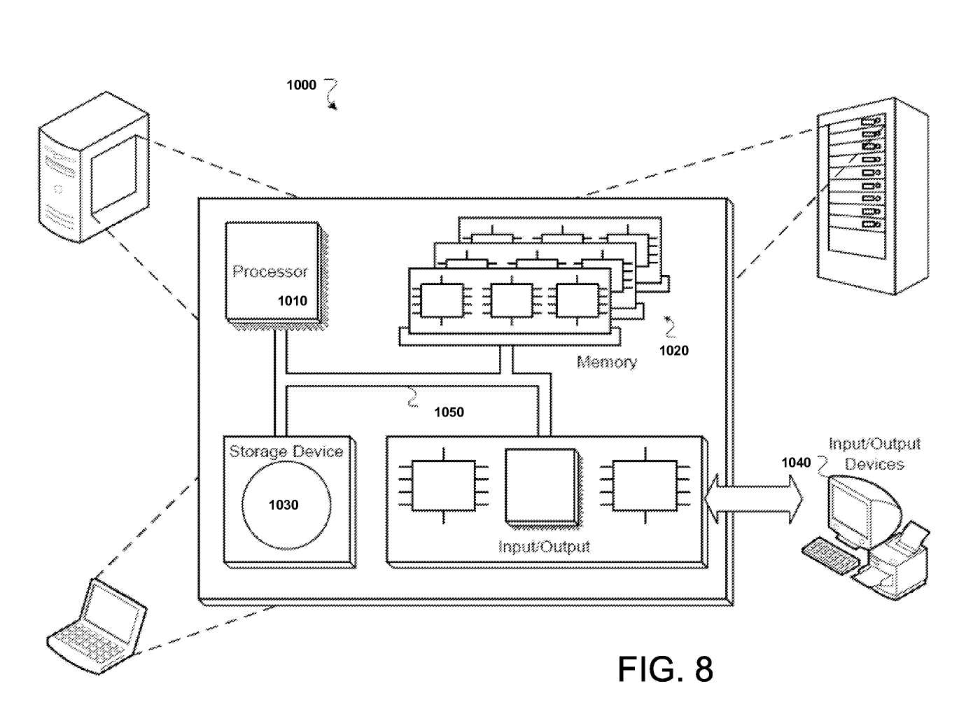

FIG. 8 is a schematic diagram of one possible implementation of a computer system 1000 that can be used for the operations described in association with any of the computer-implemented methods described herein. The system 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the system 1000. In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the system 1000. In some implementations, the memory 1020 is a computer-readable medium. The memory 1020 can include volatile memory and/or non-volatile memory.

The storage device 1030 is capable of providing mass storage for the system 1000. In one implementation, the storage device 1030 is a computer-readable medium. In various different implementations, the storage device 1030 may be a disk device, e.g., a hard disk device or an optical disk device, or a tape device.

The input/output device 1040 provides input/output operations for the system 1000. In some implementations, the input/output device 1040 includes a keyboard and/or pointing device. In some implementations, the input/output device 1040 includes a display device for displaying graphical user interfaces.

The features described can be implemented in digital electronic circuitry, or in computer hardware, software, firmware, or in combinations of them. The features can be implemented in a computer program product tangibly embodied in an information carrier, e.g., in a machine-readable storage device, for execution by a programmable processor; and features can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program includes a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Computers include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and computers and networks that form the Internet.

The computer system can include clients and servers. A client and server are generally remote from each other and typically interact through a network, such as the described one. The relationship of client and server arises by virtue of computer programs running on the respective computers and having a client-server relationship to each other.

The processor 1010 carries out instructions related to a computer program. The processor 1010 may include hardware such as logic gates, adders, multipliers and counters. The processor 1010 may further include a separate arithmetic logic unit (ALU) that performs arithmetic and logical operations.

### Other Embodiments

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method of forming a numeric data set that represents a nucleotide sequence, the method comprising:
receiving electronic information representing a nucleotide sequence comprising a contiguous series of nucleotides;
obtaining an electronic set of genetic analyzers, wherein each genetic analyzer comprises “n” nucleotides; wherein the set comprises all possible combinations of “X” different nucleotides present in the nucleotide sequences at each of “n” positions of a genetic analyzer in the set; wherein the set has a known order of genetic analyzers; wherein Xⁿ is the number of genetic analyzers in the set; and wherein each genetic analyzer has a unique sequence that provides a cut site within the nucleotide sequence at a specified site within or at an end of each segment of “n” nucleotides that is identical to a given genetic analyzer;
converting the nucleotide sequence with the ordered set of genetic analyzers into numeric data that comprises a series of groups of numbers, wherein a group of numbers is generated for each unique genetic analyzer of the set of genetic analyzers, with each number in the group comprising a total number of nucleotides between successive cut sites in the nucleotide sequence provided by the given unique genetic analyzer, and wherein the groups of numbers in the numeric data set are organized in the known order of the set of genetic analyzers; and
generating a numeric data set that comprises, in order, the first n−1 nucleotides of a 5′ end of the nucleotide sequence, the numeric data, and a 3′ nucleotide of the nucleotide sequence.

2. The computer-implemented method of claim 1, further comprising
encoding the numeric data set into an electronic representation of a genetic image; and
storing the electronic representation of the genetic image in a machine-readable storage device.

3. The computer-implemented method of claim 2, further comprising displaying the electronic representation on a display device to provide a visible genetic image.

4. The computer-implemented method of claim 2, further comprising providing the electronic representation to a printer and printing a visible genetic image on a substrate.

5. A tangible machine-readable storage device comprising a digital representation of an ordered set of genetic analyzers, wherein the set of genetic analyzers comprises a digital representation of a series of nucleotide sequences; wherein each genetic analyzer comprises “n” nucleotides; wherein the set comprises all possible combinations of “X” different nucleotides present in the nucleotide sequences at each of “n” positions of a genetic analyzer in the set; wherein the set has a known order of genetic analyzers; wherein Xⁿ is the number of genetic analyzers in the set; and wherein each genetic analyzer has a unique sequence that provides a cut site within a nucleotide sequence at a specified site within or at an end of each segment of “n” nucleotides within the nucleotide sequence that is identical to a given genetic analyzer.

6. The storage device of claim 5, wherein the order of the genetic analyzers within the set is alphabetical.

7. The storage device of claim 5, wherein n=4 and X=4.

8. The storage device of claim 5, wherein the storage device comprises a memory within a computer.

9. The storage device of claim 5, wherein the storage device comprises a portable and tangible machine-readable medium.

10. An article of manufacture comprising
a tangible object; and
a genetic image displayed on the tangible object, wherein the genetic image comprises non-alphanumeric markings in machine-readable form, wherein the genetic image when read by a machine causes a processor to decode the genetic image into a numeric data set and convert the numeric data set into a specific genetic sequence.

11. The article of manufacture of claim 10, wherein the genetic sequence is a nucleotide sequence.

12. The article of manufacture of claim 10, wherein the genetic sequence is an amino acid sequence.

13. The article of manufacture of claim 10, wherein the tangible object is a container, piece of paper or plastic, or a label.

14. The article of manufacture of claim 10, wherein the tangible object is an electronic display device.

15. The article of manufacture of claim 10, wherein the genetic image is an array of colored pixels.

16. A tangible machine-readable storage device comprising a numeric data set that when read by a machine can causes a processor to
(a) encode the numeric data set into an electronic representation of a genetic image, wherein the genetic image comprises non-alphanumeric markings in machine-readable form, wherein the genetic image when read by a machine causes a processor to decode the genetic image to provide a specific genetic sequence; or
(b) convert the numeric data set into a specific genetic sequence.

17. The tangible storage device of claim 16, wherein the storage device comprises an electronic memory within a computer, a universal serial bus compatible memory, or a magnetic or optical disk.

18. A method of generating a set of genetic analyzers, the method comprising
selecting a length “n” of a sequence of characters in each genetic analyzer;
selecting “X” as the number of different characters in each genetic analyzer;
calculating all possible combinations of “X” different characters present in a sequence at each of “n” positions of a genetic analyzer to create a basic set of Xⁿ genetic analyzers;
arranging the basic set of genetic analyzers in a specific order to create an ordered set of genetic analyzers; and
storing the ordered set of genetic analyzers in a machine-readable storage medium.

19. The method of claim 18, wherein the ordered set of genetic analyzers comprises a digital representation of a series of nucleotide sequences; wherein each genetic analyzer comprises “n” nucleotides; wherein the set comprises all possible combinations of “X” different nucleotides present in the nucleotide sequences at each of “n” positions of a genetic analyzer in the set; wherein the set has a known order of genetic analyzers; wherein Xⁿ is the number of genetic analyzers in the set; and wherein each genetic analyzer has a unique sequence that provides a cut site within a nucleotide sequence at a specified site within or at an end of each segment of “n” nucleotides within the nucleotide sequence that is identical to a given genetic analyzer.

20. The method of claim 18, wherein “n” is 4.

21. The method of claim 18, wherein the characters are amino acids.

22. A method of reading a genetic image that represents a nucleotide sequence, the method comprising
obtaining an article of manufacture of claim 10;
scanning the article of manufacture to convert markings of the genetic image into electronic data;
decoding the electronic data to obtain a numeric data set that represents at least one nucleotide sequence; and
converting the numeric data set into a nucleotide sequence.

23. The method of claim 22, wherein converting the numeric data set into a nucleotide sequence comprises the use of a known ordered set of genetic analyzers.

24. A method of comparing two or more nucleotide sequences, the method comprising
obtaining at least two articles of manufacture of claim 10 representing first and second nucleotide sequences;
scanning the articles of manufacture to convert markings of the respective genetic images into electronic data representing the first and second nucleotide sequences;
comparing the electronic data representing the first and second nucleotide sequences to locate any differences;
decoding the electronic data of any differences to obtain numeric data sets that represent the differences between the first and second nucleotide sequences; and
converting the numeric data sets using an ordered set of genetic analyzers to provide a nucleotide sequence representing the differences between the first and second nucleotide sequences.

25. A system for generating a genetic image, the system comprising
a processor;
a machine-readable storage device; and
an ordered set of genetic analyzers of claim 5 in the storage device;
wherein the processor is programmed with a program that causes the processor to:
receive electronic information representing a nucleotide sequence comprising a contiguous series of nucleotides;
obtain the ordered set of genetic analyzers from the storage device;
convert the nucleotide sequence with the ordered set of genetic analyzers into numeric data that comprises a series of groups of numbers, wherein a group of numbers is generated for each unique genetic analyzer of the set of genetic analyzers, with each number in the group comprising a total number of nucleotides between successive cut sites in the nucleotide sequence provided by the given unique genetic analyzer, and wherein the groups of numbers in the numeric data set are organized in the known order of the set of genetic analyzers; and
generate a numeric data set that comprises, in order, the first n−1 nucleotides of a 5′ end of the nucleotide sequence, the numeric data, and a 3′ nucleotide of the nucleotide sequence.

26. The system of claim 25, wherein the processor is further programmed to
encode the numeric data set into an electronic representation of a genetic image; and
store the electronic representation of the genetic image in a machine-readable storage device.

27. The system of claim 26, further comprising a display device and wherein the processor is further programmed to display the electronic representation on the display device to provide a visible genetic image.

28. The system of claim 26, further comprising a printer and wherein the processor is further programmed to provide the electronic representation to the printer and to cause the printer to print a visible genetic image on a substrate.

29. A system for reading a genetic image, the system comprising
a processor;
a machine-readable storage device;
a scanner that scans an image and converts the image into electronic data; and
an ordered set of genetic analyzers of claim 5 in the storage device;
wherein the processor is programmed with a program that causes the processor to:
obtain the electronic data from the scanner;
obtain the ordered set of genetic analyzers from the storage device;
decode the electronic data to obtain a numeric data set that represents at least one nucleotide sequence, wherein the electronic data comprises a series of groups of numbers, and wherein a group of numbers is generated for each unique genetic analyzer of the set of genetic analyzers, with each number in the group comprising a total number of nucleotides between successive cut sites in the nucleotide sequence provided by the given unique genetic analyzer, and wherein the groups of numbers in the numeric data set are organized in the known order of the set of genetic analyzers; and
convert the numeric data set into a nucleotide sequence with the ordered set of genetic analyzers.
